(19) United States
(12) Patent Application Publication
(10) Pub. No.: US 2025/0348728 A1
(43) Pub. Date: Nov. 13, 2025

(54) Dynamic Controlled Decoding

(71) Applicant: DeepMind Technologies Limited, London (GB)

(72) Inventors: Seo-Jin Bang, Mountain View, CA (US); Andrew Mingbo Dai, San Francisco, CA (US); Jie Han, San Jose, CA (US)

(21) Appl. No.: 18/661,188

(22) Filed: May 10, 2024

(51) Int. Cl. G06N 3/08

(52) U.S. Cl. CPC G06N 3/08

(57) ABSTRACT

An example method includes inputting a first segment of a sequence into a machine-learned sequence processing model, wherein the first segment comprises data associated with a sequence generation request. The example method includes generating, in parallel, a plurality of candidate second segments. The example method includes generating a plurality of scores respectively for the plurality of candidate second segments using a segment quality model to generate a first component score and a response quality model to generate a second component score. The example method includes selecting, based on the plurality of scores, a second segment based on the plurality of candidate second segments. The example method includes processing the first segment and the selected second segment using the machine-learned sequence processing model to generate a third segment. The example method includes returning the selected second segment and the third segment in response to the sequence generation request.

### BACKGROUND

A computer can receive inputs. The computer can execute instructions to process the inputs to generate outputs using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In an aspect, the present disclosure provides an example computing system configured for efficient generation of multiple candidate segments of a multi-segment sequence using a machine-learned sequence processing model. In some implementations, the example computing system includes one or more processors. In some implementations, the example computing system includes one or more non-transitory computer-readable media storing instructions that are executable by the one or more processors to cause the computing system to perform operations. In some implementations of the example computing system, the operations include inputting a first segment of a sequence into a machine-learned sequence processing model, wherein the first segment includes data associated with a sequence generation request. In some implementations of the example computing system, the operations include generating, in parallel, a plurality of candidate second segments. In some implementations of the example computing system, the operations include generating a plurality of scores respectively for the plurality of candidate second segments using a segment quality model to generate a first component score and a response quality model to generate a second component score. In some implementations of the example computing system, the operations include selecting, based on the plurality of scores, a second segment based on the plurality of candidate second segments. In some implementations of the example computing system, the operations include processing the first segment and the selected second segment using the machine-learned sequence processing model to generate a third segment. In some implementations of the example computing system, the operations include returning the selected second segment and the third segment in response to the sequence generation request.

In some implementations of the example computing system, the segment quality model was trained using segment-level feedback signals to generate scores for input segments. In some implementations of the example computing system, the response quality model was trained using response-level feedback signals to generate a score for a given input segment based on an expected quality of a response that contains the given input segment.

In some implementations of the example computing system, the segment quality model was trained using a segment label pair, the segment label pair including a training segment and a segment-level label.

In some implementations of the example computing system, the response quality model was trained using a response label pair, the response label pair including a training segment and a response-level label, wherein the response-level label was obtained for a multi-segment response that contained the training segment.

In some implementations of the example computing system, the segment quality model was trained using reinforcement learning with the segment-level feedback signals providing a reward. In some implementations of the example computing system, the response quality model was trained using reinforcement learning with the response-level feedback signals providing a reward.

In some implementations of the example computing system, generating the plurality of scores includes, for a respective candidate second segment, determining a composite score using the first component score and the second component score.

In some implementations of the example computing system, the composite score is based on a weighted combination of the first component score and the second component score, wherein the weighted combination is weighted based on an ordinal value associated with the respective candidate second segment.

In some implementations of the example computing system, at least one of the segment quality model or the response quality model includes a machine-learned sequence processing model configured to process a given input segment and autoregressively generate an output segment that indicates a score.

In some implementations of the example computing system, the output segment indicates numerical digits of the score.

In some implementations of the example computing system, the machine-learned sequence processing model is configured to process the given input segment in conjunction with an instruction segment that instructs the machine-learned sequence processing model to provide an evaluation for one or more attributes of the given input segment.

In some implementations of the example computing system, the segment quality model includes a first machine-learned sequence processing model configured to process a given input segment and autoregressively generate an output segment that indicates a score. In some implementations of the example computing system, the response quality model includes a second machine-learned sequence processing model configured to process a given input segment and autoregressively generate an output segment that indicates a score.

In an aspect, the present disclosure provides an example computing system configured for efficient generation of multiple candidate segments of a multi-segment sequence using a machine-learned sequence processing model. In some implementations, the example computing system includes one or more processors. In some implementations, the example computing system includes one or more non-transitory computer-readable media storing instructions that are executable by the one or more processors to cause the computing system to perform operations. In some implementations of the example computing system, the operations include inputting a first segment of a sequence into a machine-learned sequence processing model, wherein the first segment includes data associated with a sequence generation request. In some implementations of the example computing system, the operations include generating, in parallel, a plurality of candidate second segments of the sequence. In some implementations of the example computing system, generating a respective candidate second segment of the plurality of candidate second segments includes sampling one or more output values from the machine-learned sequence processing model to append to the respective candidate second segment. In some implementations of the example computing system, generating a respective candidate second segment of the plurality of candidate second segments includes sampling, based on the one or more output values, a designated control value that terminates the respective candidate second segment. In some implementations of the example computing system, the operations include, responsive to determining that the plurality of candidate second segments satisfy a completion threshold, generating a plurality of scores respectively for the plurality of candidate second segments. In some implementations of the example computing system, the operations include selecting, based on the plurality of scores, a second segment based on the plurality of candidate second segments. In some implementations of the example computing system, the operations include processing the first segment and the selected second segment using the machine-learned sequence processing model to generate a third segment. In some implementations of the example computing system, the operations include returning the selected second segment and the third segment in response to the sequence generation request.

In some implementations of the example computing system, generating the third segment includes generating, in parallel, a plurality of candidate third segments of the sequence. In some implementations of the example computing system, generating a respective candidate third segment of the plurality of candidate third segments includes sampling one or more third segment output values from the machine-learned sequence processing model to append to the respective candidate third segment. In some implementations of the example computing system, generating a respective candidate third segment of the plurality of candidate third segments includes sampling, based on the one or more third segment output values, a designated control value that terminates the respective candidate third segment. In some implementations of the example computing system, generating the third segment includes, responsive to determining that the plurality of candidate third segments satisfy the completion threshold, generating a plurality of third segment scores respectively for the plurality of candidate third segments. In some implementations of the example computing system, generating the third segment includes selecting, based on the plurality of third segment scores, the third segment.

In some implementations of the example computing system, the designated control value that terminates the respective candidate second segment includes a control value that represents a terminal punctuation character.

In some implementations of the example computing system, the designated control value that terminates the respective candidate second segment includes a control value that represents a terminal punctuation character. In some implementations of the example computing system, the designated control value that terminates the respective candidate third segment includes a different terminal punctuation character from the designated control value that terminates the respective candidate second segment.

In some implementations of the example computing system, determining that the plurality of candidate second segments satisfy a completion threshold includes determining that a threshold quantity of the plurality of candidate second segments include a designated control value.

In some implementations of the example computing system, the operations include padding the respective candidate second segment until a predetermined segment length is reached. In some implementations of the example computing system, the operations include wherein determining that the plurality of candidate second segments satisfy a completion threshold includes reaching the predetermined segment length.

In some implementations of the example computing system, processing the first segment and the selected second segment using the machine-learned sequence processing model to generate the third segment includes broadcasting the selected second segment across a batch dimension.

In some implementations of the example computing system, processing the first segment and the selected second segment using the machine-learned sequence processing model to generate the third segment includes broadcasting one or more cached attention values associated with the selected second segment across the batch dimension.

In some implementations of the example computing system, generating, in parallel, the plurality of candidate second segments of the sequence includes sharing one or more cached attention values for the first segment across the plurality of candidate second segments.

In some implementations of the example computing system, generating, in parallel, the plurality of candidate second segments of the sequence includes sharing one or more cached attention values for the first segment for the generation of the plurality of candidate second segments. In some implementations of the example computing system, generating, in parallel, the plurality of candidate third segments of the sequence includes sharing the one or more cached attention values for the first segment and one or more cached attention values for the selected second segment for the generation of the plurality of candidate third segments.

In some implementations of the example computing system, the operations include processing multiple batch groups, wherein each batch group is associated with a different query. In some implementations of the example computing system, the operations include responsive to determining that the multiple batch groups together satisfy the completion threshold, generating scores for candidate segments in each of the multiple batch groups.

In an aspect, the present disclosure provides an example computing system configured for training a plurality of scoring models for efficient generation of multiple candidate segments of a multi-segment sequence using a machine-learned sequence processing model. In some implementations, the example computing system includes one or more processors. In some implementations, the example computing system includes one or more non-transitory computer-readable media storing instructions that are executable by the one or more processors to cause the computing system to perform operations. In some implementations of the example computing system, the operations include obtaining one or more feedback signals associated with an intermediate sequence state of a reference sequence. In some implementations of the example computing system, the operations include generating, using a machine-learned segment quality model, a segment-level component score for the intermediate sequence state. In some implementations of the example computing system, the operations include generating, using a machine-learned response quality model, a response-level component score for the intermediate sequence state. In some implementations of the example computing system, the operations include updating the machine-learned segment quality model and the machine-learned response quality model based on the one or more feedback signals.

In one example aspect, the present disclosure provides example non-transitory computer readable media storing instructions that are executable by one or more processors to cause a computing system to perform one or more operations of any one or more implementations of the example computing systems described above.

In one example aspect, the present disclosure provides an example computer-implemented method of performing one or more operations of any one or more implementations of the example computing systems described above.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to describe the related principles.

### BRIEF DESCRIPTION OF THE DRAWINGS

Detailed discussion of embodiments directed to one of ordinary skill in the art is set forth in the specification, which makes reference to the appended figures.

FIG. 1 is a block diagram of aspects of an example system for implementing decoding techniques according to example implementations of aspects of the present disclosure.

FIG. 2 is a block diagram of aspects of an example system for implementing decoding techniques according to example implementations of aspects of the present disclosure.

FIG. 3 is a block diagram of aspects of an example system for implementing decoding techniques according to example implementations of aspects of the present disclosure.

FIG. 4 is a block diagram of aspects of an example system for implementing decoding techniques according to example implementations of aspects of the present disclosure.

FIG. 5 is a block diagram of aspects of an example system for implementing decoding techniques according to example implementations of aspects of the present disclosure.

FIG. 6A is a block diagram of aspects of an example system for implementing decoding techniques according to example implementations of aspects of the present disclosure.

FIG. 6B is a block diagram of aspects of an example system for implementing decoding techniques according to example implementations of aspects of the present disclosure.

FIG. 6C is a block diagram of aspects of an example system for implementing decoding techniques according to example implementations of aspects of the present disclosure.

FIG. 7 is a block diagram of aspects of an example system for implementing decoding techniques according to example implementations of aspects of the present disclosure.

FIG. 8 is a block diagram of aspects of an example system for implementing decoding techniques according to example implementations of aspects of the present disclosure.

FIG. 9 is a block diagram of aspects of an example system for implementing decoding techniques according to example implementations of aspects of the present disclosure.

FIG. 10A is a block diagram of aspects of an example system for implementing decoding techniques according to example implementations of aspects of the present disclosure.

FIG. 10B is a block diagram of aspects of an example system for implementing decoding techniques according to example implementations of aspects of the present disclosure.

FIG. 10C is a block diagram of aspects of an example system for implementing decoding techniques according to example implementations of aspects of the present disclosure.

FIG. 11A is a block diagram of aspects of an example system for implementing decoding techniques according to example implementations of aspects of the present disclosure.

FIG. 11B is a block diagram of aspects of an example system for implementing decoding techniques according to example implementations of aspects of the present disclosure.

FIG. 12 is a block diagram of aspects of an example system for implementing decoding techniques according to example implementations of aspects of the present disclosure.

FIG. 13 is a block diagram of aspects of an example system for implementing decoding techniques according to example implementations of aspects of the present disclosure.

FIG. 14 is a block diagram of aspects of an example system for implementing decoding techniques according to example implementations of aspects of the present disclosure.

FIG. 15 is a block diagram of aspects of an example system for implementing decoding techniques according to example implementations of aspects of the present disclosure.

FIG. 16 is a block diagram of aspects of an example system for implementing decoding techniques according to example implementations of aspects of the present disclosure.

FIG. 17 is a block diagram of aspects of an example system for implementing decoding techniques according to example implementations of aspects of the present disclosure.

FIG. 18 is a flow chart diagram illustrating an example method for training a machine-learned model according to example implementations of aspects of the present disclosure.

FIG. 19 is a flow chart diagram illustrating an example method for implementing a machine-learned model according to example implementations of aspects of the present disclosure.

FIG. 20 is a flow chart diagram illustrating an example method for implementing a machine-learned model according to example implementations of aspects of the present disclosure.

FIG. 21 is a flow chart diagram illustrating an example method for training a machine-learned model according to example implementations of aspects of the present disclosure.

FIG. 22 is a block diagram of an example processing flow for using machine-learned model(s) to process input(s) to generate output(s) according to example implementations of aspects of the present disclosure.

FIG. 23 is a block diagram of an example sequence processing model according to example implementations of aspects of the present disclosure.

FIG. 24 is a block diagram of an example technique for populating an example input sequence for processing by a sequence processing model according to example implementations of aspects of the present disclosure.

FIG. 25 is a block diagram of an example model development platform according to example implementations of aspects of the present disclosure.

FIG. 26 is a block diagram of an example training workflow for training a machine-learned model according to example implementations of aspects of the present disclosure.

FIG. 27 is a block diagram of an inference system for operating one or more machine-learned model(s) to perform inference according to example implementations of aspects of the present disclosure.

FIG. 28 is a block diagram of an example networked computing system according to example implementations of aspects of the present disclosure.

FIG. 29 is a block diagram of an example computing device according to example implementations of aspects of the present disclosure.

FIG. 30 is a block diagram of an example computing device according to example implementations of aspects of the present disclosure.

Reference numerals that are repeated across plural figures are intended to identify the same features in various implementations.

### DETAILED DESCRIPTION

Example implementations of the present disclosure improve the alignment of a primary machine-learned model with desired performance criteria using lightweight and modular output filter models. One traditional approach to aligning model behavior includes training the model to generate outputs having the desired characteristics in an open loop. But in some cases retraining a primary machine-learned model to follow a given set of output preferences can require large amounts of compute and data, especially for large model sizes.

An alternative approach to align model behavior includes applying an output filter to select a preferred output from among candidate outputs. Such approaches in the past have typically been limited to open-loop generation: the primary model would generate a number of candidates in full, and each completed candidate would then be evaluated for selection, ranking, re-generation, etc. Because the generations are performed open-loop, the model may not have any mechanism for detecting suboptimal candidate quality mid-generation, and may thus continue to expend compute to complete a given candidate even if containing errors early in the output.

Example implementations of the present disclosure, in contrast, provide a closed loop evaluation mechanism for more efficiently applying an output filter. A primary machine-learned model can generate each candidate output in segments. The candidate segments can be generated in groups, and the output filter can, for each group of candidate segments, select a candidate from among the group. This candidate can be the basis for further generation for some or all of the candidates. For example, the best candidate segment can replace all other candidates such that generation of the next segment for each candidate is based on the best candidate. Conversely, suboptimal candidates can be dropped, with no further compute being expended to generate content that follows from those candidates.

An example output filter can use a machine-learned scoring model to evaluate candidate segments. A machine-learned scoring model can include one or more machine-learned components that provide different component evaluations. The component evaluations can be combined to generate a composite evaluation. The combination can be based on hand-tuned or machine-learned weights. The weights can be fixed or can vary as a function of an ordinal value of a segment.

In an example, the machine-learned scoring model includes a component that evaluates the quality of a segment for the content it contains (e.g., a segment-level scorer). In an example, the machine-learned scoring model includes a component that evaluates the quality of a segment based on an estimation of a resulting completed response that includes the segment (e.g., a response-level scorer).

Advantageously, example implementations of the present disclosure can intelligently segment candidate outputs according to semantic units. A semantic unit can include a phrase, clause, sentence, parenthetical, paragraph, page, etc. A semantic unit can be demarcated using one or more control values or characters (e.g., punctuation, white space, tags, etc.). To segment by semantic unit, a primary model can continue generation of a candidate segment until reaching a designated control value. After satisfying a completion threshold across the candidates (e.g., all candidates reach control value or other stopping criterion), the scoring model(s) can evaluate the candidate segments.

In this manner, for instance, the scoring model(s) can evaluate cohesive units of information so that the output filter can better compare like-for-like. For example, the two sentences “we ate ice cream after lunch” and “after lunch, we ate ice cream” can be evaluated as equivalent when viewed as whole sentences but can appear dissimilar if compared based on, for instance, the first three words. By enabling higher-quality comparisons, example implementations of the present disclosure can better evaluate partial responses for evaluating the generation of content in closed loop.

Example implementations of the present disclosure can provide compute-efficient mechanisms for applying closed-loop output filters to align output quality with desired criteria. Closed loop evaluation can enable more efficient operation by stopping generation of erroneous or otherwise suboptimal generations mid-generation, instead of generating a full response that would only be deleted. Furthermore, by carrying forward each selected segment, the output filter can effectively traverse a larger search tree by branching at each new segment, instead of only branching over complete responses. This in turn can lead to higher quality outputs (e.g., higher recall) without increasing a number of full candidate responses. In a similar fashion, intelligent segmentation over semantic units can facilitate more accurate prediction of output quality, thereby improving overall response precision.

A technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Example implementations of the present disclosure are described in more detail herein with respect to the enclosed figures.

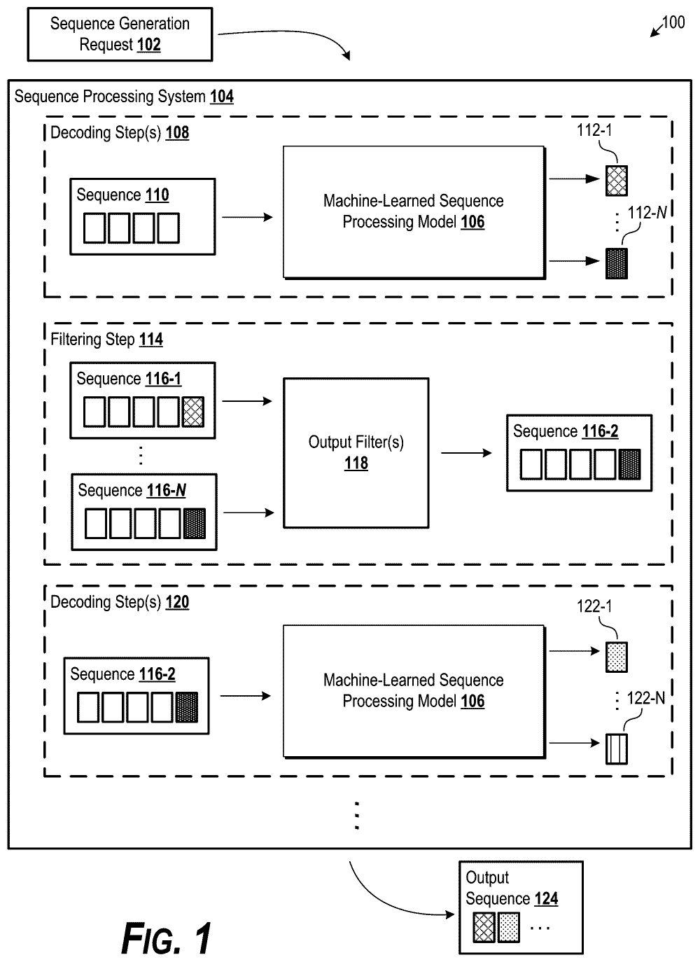

FIG. 1 is a block diagram of an example system 100 for sequence processing using a machine-learned sequence processing model. System 100 can receive a sequence generation request 102. System 100 can input sequence generation request 102 into sequence processing system 104. Sequence processing system 104 can implement a machine-learned sequence processing model 106 to perform operations to service sequence generation request 102. For instance, machine-learned sequence processing model 106 can execute one or more decoding steps 108 to predict or generate sequence elements.

For instance, in decoding step 108, machine-learned sequence processing model 106 can process an initial sequence 110 and predict a first candidate sequence element 112-1 (e.g., a likely next element, such as a next token in the sequence) and a second candidate sequence element 112-2. Multiple candidate sequence elements can be generated in parallel. Multiple elements can be generated for each candidate sequence.

In a filtering step 114, the candidates output from decoding step(s) 108 can be combined with the shared initial sequence 110 into candidate sequences 116-1 and 116-2. Output filter(s) 118 can process candidate sequences 116-1 and 116-2 to select a candidate that aligns with a prescribed characteristic profile (e.g., satisfying a score, metric, or other criterion). For example, output filter(s) 118 can determine that sequence 116-2 aligns with a prescribed characteristic profile.

Based on the output from output filter(s) 118, sequence 116-2 can be the basis for further sequence generation by machine-learned model 106 in decoding step 120. Machine-learned model 106 can process sequence 116-2 and generate a plurality of candidate sequence elements 122-1 and 122-2. Multiple candidate sequence elements can be generated in parallel. Multiple elements can be generated for each candidate sequence.

Decoding and filtering steps can be iteratively implemented to obtain an output sequence 122. In this manner, for instance, alignment with prescribed characteristic profiles can be checked and enforced mid-generation to more efficiently obtain an output sequence 122 that aligns with one or more prescribed criteria.

System 100 can be or include a standalone application or service or can be implemented as part of a larger application or service. For instance, system 100 can be configured to receive requests via an application programming interface (API) and return responses or otherwise execute actions responsive to the request. System 100 can return responses or execute actions using content generated by sequence processing system 104. The content can include response content (e.g., content to return responsive to a request), functional content (e.g., content for input to tools or other functions), record content (e.g., log data, traces), etc.

Sequence generation request 102 can be or include data for initiating a sequence processing task. Sequence generation request 102 can include data for input to machine-learned sequence processing model 106 (e.g., a partial input for completion, instruction data for instructing the model, etc.). Sequence generation request 102 can include data for selecting or otherwise determining an input to machine-learned sequence processing model 106 (e.g., an instruction for sequence processing system 104 to input a particular data item).

Sequence generation request 102 can include data of one or multiple modalities. Sequence generation request 102 can include one or multiple modalities of text, image, audio, or spatial data, as some examples.

Sequence processing system 104 can be or include a standalone application or service or can be implemented as part of a larger application or service (e.g., system 100). Sequence processing system 104 can manage interactions with machine-learned sequence processing model 106. Sequence processing system 104 can control the inputs to, outputs from, and execution parameters of machine-learned sequence processing model 106.

Sequence processing system 104 can directly control interactions with machine-learned sequence processing model 106. For instance, sequence processing system 104 can interact at a hardware level with the devices executing operations of machine-learned sequence processing model 106, such as to control distribution of model parameters and model inputs across different accelerator devices executing portions of machine-learned sequence processing model 106, inspect latent or hidden states of machine-learned sequence processing model 106, etc.

Sequence processing system 104 can interact and control machine-learned sequence processing model 106 using one or more application programming interfaces. For instance, a low-level control system can execute on the same or different devices as sequence processing system 104. The low-level control system can expose an application programming interface to sequence processing system 104 to permit sequence processing system 104 to interact with and control one or more operations of machine-learned sequence processing model 106.

Sequence processing system 104 can manage an input sequence for a machine-learned sequence processing model 106. Sequence processing system 104 can provide an initial input sequence. Sequence processing system 104 can insert an input sequence into a buffer for processing. Sequence processing system 104 can update an existing input sequence. For instance, sequence processing system 104 can append elements to an input sequence for further processing. Sequence processing system 104 can replace portions of an input sequence and resume processing with the updated input sequence.

Sequence processing system 104 can pause execution of machine-learned sequence processing model 106 when performing operations to insert or update an input sequence. Sequence processing system 104 can perform operations to insert or update an input sequence without pausing (e.g., without control of) execution of machine-learned sequence processing model 106. For instance, machine-learned sequence processing model can perform prediction cycles on a regular cadence, and sequence processing system 104 can insert or update input sequences during intervals between prediction cycles, during prediction cycles (e.g., skipping processing a particular input sequence for one or more cycles while updating the input sequence, etc.).

Sequence processing system 104 can facilitate predictions for multiple requests 102 in parallel. Multiple requests can be received and processed at the same or different times (e.g., staggered initiation with overlapping execution). Sequence processing system 104 can perform the techniques described herein for multiple different requests 102 at the same or different times (e.g., staggered, overlapping, etc.).

Machine-learned sequence processing model 106 can be or include one or more components configured to receive an input sequence, process the input sequence using learned parameters that operate over the input sequence to extract semantic meaning in the input sequence, and generate one or more sequence elements based on the input sequence. Machine-learned sequence processing model 106 can predict one or more sequence elements based on (explicitly or implicitly) a probability conditioned on the input sequence. For instance, machine-learned sequence processing model 106 can predict one or more sequence elements that are expected to follow the input sequence (e.g., a next token prediction). Machine-learned sequence processing model 106 can predict one or more sequence elements that are expected to populate a position indicated in the input sequence (e.g., an infill task).

Machine-learned sequence processing model 106 can include an autoregressive sequence processing model. For example, machine-learned sequence processing model 106 can process an initial sequence to can predict a first sequence element, add the first sequence element to the input, and then predict another sequence element based on a combination of the initial sequence and the first sequence element. This process can repeat until a stopping condition is reached (e.g., prediction of a stop token, reaching a sequence length limit, etc.).

Machine-learned sequence processing model 106 can process multiple input sequences in parallel. For instance, machine-learned sequence processing model 106 can perform one or more computations that can be parallelized along a batch dimension. For instance, machine-learned sequence processing model 106 can process one or more values of a sequence using matrix or tensor operations. The matrix or tensors processed in the operations can contain a batch dimension. Operations distributed across the batch dimension can be independent.

Using a batch dimension can increase an efficiency of sequence processing. Processing multiple inputs using a machine-learned model by processing a single input at a time can introduce a latency between each processed input equal to the time taken for the input to be completely processed by the model. Duplicating an entire model to naively process multiple single inputs in parallel can increase a computation cost by an amount equal to an entire model instance for each input. In contrast, by parallelizing computation along a batch dimension, a given set of model parameters can efficiently operate over multiple batched inputs.

Machine-learned sequence processing model 106 can leverage efficient batch computations to generate multiple candidate sequence elements in parallel for a given input sequence. These candidates can be evaluated at various checkpoints using an output filter and a selected candidate can be merged into the given input sequence and adopted for future generations based on the input sequence.

Decoding step 108 illustrates an example forward pass through machine-learned sequence processing model 106 in which an initial sequence 110 is used to predict multiple candidate sequence elements 112-1, . . . , 112-N. Multiple candidate streams (e.g., N streams) can be decoded in parallel (e.g., parallelized along a batch dimension). Multiple decoding steps can be executed for each stream to generate candidate segments, with each segment containing one or multiple sequence elements.

Sequence 110 can include one or multiple sequence elements. A sequence element (e.g., elements 112-1, . . . , 112-N) can be a numerical or symbolic representation of information. A sequence element can correspond to a token. A token can be a unit of expressive content. For instance, text tokens can include word or subword tokens that represent whole or partial words, character tokens that represent individual characters or groups of characters or symbols, etc. Image tokens can include image patches or embeddings thereof. Many different modalities of data can be tokenized, including text, image, audio, video, sensor data, etc.

Sequence 110 can include data from one or multiple modalities. A modality of elements 112-1, . . . , 112-N can be the same as or different from modalities represented by sequence 110. Elements 112-1, . . . , 112-N can all be the same modality, or at least one element of elements 112-1, . . . , 112-N can be a different modality than at least one other element of elements 112-1, . . . , 112-N.

Even if the entire sequence is not yet complete, the candidate segments respectively containing elements 112-1, . . . 112-N can provide a look at different versions of a portion of the output sequence. Sequence processing system 104 can apply one or more filtering operations to select among the candidate segments.

Filtering step 114 illustrates an example process for selecting a candidate. Filtering step 114 can execute responsive to a trigger condition. For instance, a trigger condition can include a completion threshold for decoding step(s) 108. An example completion threshold is a segment length metric, such that filtering step 114 is triggered responsive to at least one segment or all segments reaching a prescribed segment length. An example completion threshold is based on a detection of a control element or control value in one or more of the candidate segments, such that filtering step 114 is triggered responsive to one or multiple or all of the candidate segments containing the control element.

Filtering step 114 can include evaluating the current state of the sequence for each candidate generation. For instance, the candidate element(s) 112-1, . . . , 112-N can be joined to input sequence 110 to form sequences 116-1, . . . , 116-N. Output filter(s) 118 can process sequences 116-1, . . . , 116-N to obtain a selected sequence (e.g., sequence 116-2) selected from among sequences 116-1, . . . , 116-N.

Filtering step 114 can include detecting a control value using a lookup operation. For instance, each decoded value can be compared against a reference list of control values. If a decoded value is found in the list, filtering step 114 can proceed. If the decoded value is not found in the list, filtering step 114 does not proceed and further generations are processed (e.g., additional tokens are decoded by the model to append to input sequence 110 in addition to candidate element(s) 112-1, . . . , 112-N).

Filtering step 114 can include detecting a semantic unit directly using a machine-learned model. For instance, output filter(s) 118 can invoke one or more machine-learned model(s) at each decoding step (e.g., for each new decoded token) to evaluate whether a semantic unit boundary has been reached (e.g., a terminus of a semantic unit). For instance, one or more machine-learned model(s) can be trained to evaluate an input sequence and return an indicator of whether the input sequence communicates a complete thought, a complete concept, a grammatically complete phrase or clause, etc. If the one or more machine-learned models return, for the current state of a candidate sequence (e.g., sequence 110 plus one of candidate element(s) 112-1, . . . , 112-N), an indicator that the candidate sequence terminates with a semantic unit, filtering step 114 can proceed. If the one or more machine-learned models return, for the current state of a candidate sequence (e.g., sequence 110 plus one of candidate element(s) 112-1, . . . , 112-N), an indicator that the candidate sequence does not terminate with a complete semantic unit (e.g., the sequence terminates with a partial semantic unit), filtering step 114 does not proceed and further generations are processed (e.g., additional tokens are decoded by the model to append to input sequence 110 in addition to candidate element(s) 112-1, . . . , 112-N).

In an example, the one or more models that evaluate whether the sequence state terminates with a complete semantic unit can perform a screening operation prior to evaluation of the sequence state by one or more scoring models. For instance, a screening operation can be expressed in the following pseudocode:

```
  if is_semantic_unit(sequence):
    evaluate(sequence)
where is_semantic_unit( ) and evaluate( ) invoke the same or different models using multiple
queries.
```

In an example, the one or more models that evaluate whether the sequence state terminates with a complete semantic unit can simultaneously perform a screening operation and the evaluation of the sequence state. For instance, a screening operation can be expressed in the following pseudocode:

evaluate(sequence)
where evaluate( ) returns a score if the sequence terminates with a semantic unit and, if not,
returns a response indicating to continue generations.

Output filters 118 can include one or more components configured to score, rank, or otherwise evaluate one or more input sequences for outputting a reduced numbed of sequences. For instance, output filters 118 can indicate a top or top-K set of sequences from a group of input sequences by applying a prescribed policy or scoring mechanism. Output filters 118 can implement temperature sampling or other exploratory mechanisms, such that the output of the filter can balance adherence to a policy with increased diversity of output.

Output filters 118 can include one or more scoring models. Output filters 118 can include multiple different scoring models configured to generate multiple different component scores for each input sequence. Output filters 118 can generate an aggregate score, ranking, or other selection metric based on the component scores.

Output filters 118 can identify a candidate sequence to carry forward for continuing further generations based thereon (e.g., conditioned thereon). The candidate sequence can be used as a basis for multiple of or all of the N decoding streams.

Output filters 118 can determine that no candidate sequence satisfies a threshold criterion for carrying forward for continuing further generations based thereon (e.g., conditioned thereon). For instance, a quality filter can enforce at least a predetermined level or category of quality (e.g., a quality score greater than a particular value, a presence or absence of a quality or content class, a true or false boolean quality indicator, etc.). Any candidate that does not satisfy the threshold can be ignored as a viable candidate.

If no candidate satisfies the threshold, or if an insufficient number of candidates satisfy the threshold, sequence processing system 104 can repeat decoding step(s) 108 with the same sequence 110 to generate new candidates 112-1, . . . , 112-N for input again to output filter(s) 118. This can repeat until at least one candidate satisfies the threshold and can be carried forward. In this manner, for instance, the decoding stream(s) can “backtrack” and ensure at least a minimum quality level with respect to predetermined thresholds.

The thresholds can be evaluated by one or more machine-learned models that can be different from one or more scoring models or the same as one or more scoring models used by output filter(s) 118.

Decoding operations performed after backtracking can be modified to improve a likelihood of satisfying the threshold. For example, an input to machine-learned model 106 can be edited or augmented to include an instruction to align with an attribute measured by the threshold. Editing the input can involve inserting an additional instruction sequence into a decoding stream (e.g., editing sequence 110 to include additional instruction content).

Backtracking can be capped at a certain number of attempts. After failing to satisfy a threshold for a capped number of attempts, sequence processing system 104 can continue to generate content with the highest-score candidate. A flag value (e.g., returned responsive to request 102 in a data object containing output 124) can be set for downstream systems to recognize that backtracking failed to overcome the threshold. A downstream system can include a manual review system (e.g., for human content review), an automated review system, etc. A downstream system can include a user terminal that displays a caution or warning label indicating that a certain quality threshold was not met (e.g., regarding substantiation, groundedness, etc.). After failing to satisfy a threshold for a capped number of attempts, sequence processing system 104 can abort any further generations based on sequence 110. Sequence processing system 104 can return, responsive to request 102, a response indicating that sequence generation failed.

Decoding step(s) 120 can resume generating content for the sequence after identifying, using filtering step 114, a selected candidate. For instance, selected sequence 116-2 can be adopted as a current state of the sequence. Machine-learned sequence processing model 106 can process sequence 116-2 to generate multiple candidate elements 122-1, . . . , 122-N in N processing streams (e.g., parallelized along a batch dimension). Attention values for the selected candidate segment computed in decoding step(s) 108 can be re-used in decoding step(s) 120. For instance, in addition to broadcasting the tokens of the selected candidate, sequence processing system 104 can broadcast the cached attention values for the selected candidate segment.

This process can iteratively continue until a stopping criterion is satisfied. For instance, a stopping criterion can include detection of an end-of-sequence element in a selected candidate.

Output sequence 124 can include the segments or elements generated by machine-learned sequence processing model 106. Output sequence 124 can include or omit an initial segment, such as sequence 110.

Sequence processing system 104 can return output sequence 124 responsive to sequence processing request 102. Sequence processing system 104 can return output sequence 124 to the same system or a different system as that which issued request 102.

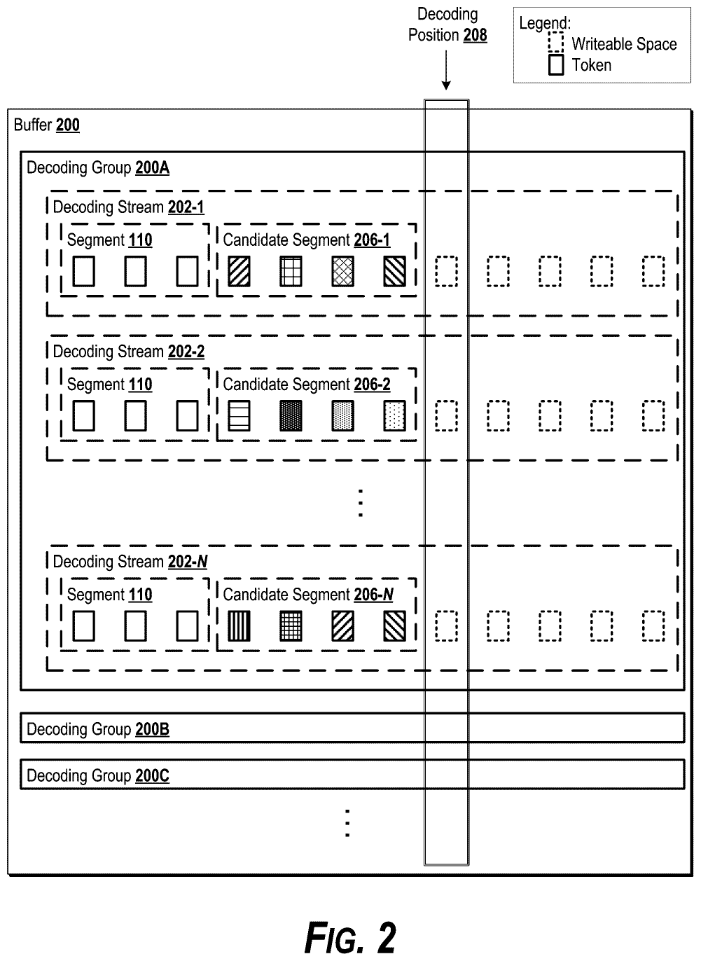

FIG. 2 is an example illustration of a buffer 200 for generating multiple candidate segments for a given input segment with batchwise parallelization. Buffer 200 can provide a queue for accumulating input sequence elements throughout the decoding iterations. Buffer 200 can collect sequences across a number of groups, where each group contains a set of decoding streams that generate candidates for a given segment associated with that group. For instance, decoding group 200A can include N decoding streams 202-1, 202-2, . . . , 202-N for generating N candidate segments for generating a response sequence for a given query. Decoding groups 200B and 200C—although illustrated in an abbreviated manner, for readability—can each contain a different set of decoding streams (having the same or different numbers of streams) for generating candidate segments for different responses for different queries.

With reference to decoding group 200A as a representative example, each of decoding streams 202-1, 202-2, . . . , 202-N can include or reference initial sequence segment 110. Machine-learned sequence processing model 106 can generate, in parallel, multiple elements or tokens based on segment 110. These tokens can be written to buffer 200 in the corresponding decoding stream to form candidate segments 206-1, 206-2, . . . , 206-N within each decoding stream. At each decoding step, for example, machine-learned sequence processing model 106 can process, as an input, the sequence preceding a current decoding position. The input can be a tensor having a batch dimension corresponding to the decoding streams. Based on processing the input, machine-learned sequence processing model 106 can generate N outputs that respectively correspond to the N decoding streams. These N outputs can be inserted at decoding position 208.

For instance, to generate the first elements of candidate segments 206-1, 206-2, . . . , 206-N, machine-learned sequence processing model 106 can process segment 110. Machine-learned sequence processing model 106 can decode or otherwise generate (e.g., probabilistically sample) a next sequence element for each decoding stream (e.g., independently for each decoding stream).

Buffer 200 can include storage or memory allocated for persisting sequence data. Buffer 200 can be persisted in volatile or non-volatile memory or storage. Buffer 200 can be implemented using one or multiple memory chips on one device or multiple connected devices. Buffer 200 can be contiguous or not contiguous. Buffer 200 can be pre-allocated or allocated just-in-time.

Buffer 200 can store new sequence element or token values in writeable space. Writeable space can include an unused portion of the buffer or a portion that only contains stale data. For instance, buffer 200 can be a circular buffer, and stale data from a prior cycle of the buffer can be overwritten.

Decoding streams 202-1, 202-2, . . . , 202-N can correspond to independently processed sequences distributed along a batch dimension of machine-learned sequence processing model 106. For example, the N decoding streams can correspond to the N streams described above with respect to FIG. 1.

Decoding streams 202-1, 202-2, . . . , 202-N can be associated with stored token values generated for the respective sequences. Decoding streams 202-1, 202-2, . . . , 202-N can be associated with cached intermediate values (e.g., attention values, such as KV cache values) for the respective sequences.

Segment 110 can be broadcast across the N decoding streams of group 200A. Broadcasting can include duplicating the values of a segment in multiple positions in buffer 200 corresponding to each of the streams. Broadcasting can include storing a single instance of the values of a segment and duplicating pointers to the values in multiple positions in buffer 200 corresponding to each of the streams.

Segment 110 can be processed by machine-learned sequence processing model 106 to compute one or more attention values. For instance, machine-learned sequence processing model 106 can compute self-attention values over segment 110. At least some of the attention values over segment 110 can be shared across the decoding streams. The computation of these attention values can be performed in duplicate across the batch dimension of machine-learned sequence processing model 106. The computation of these attention values can be performed once for all streams. For instance, a prefill system can process segment 110 to compute the attention values and populate buffer 200 with the computed values. The prefill system can implement a different instance of machine-learned sequence processing model 106 configured for improved performance on the prefill task (e.g., without being configured to generate N candidate segments).

Candidate segments 206-1, 206-2, . . . , 206-N can be generated (e.g., autoregressively) by machine-learned sequence processing model 106 based on segment 110. Each of the candidate segments can have one or more properties and characteristics as described above with respect to segment 110 of FIG. 1.

Decoding position 208 can indicate a current position in buffer 200 at which new values (e.g., values output by machine-learned sequence processing model 106, padding values) are written. Decoding position 208 can advance for all the streams together in unison. For instance, sequence processing system 104 can read values directly from buffer 200 and obtain a tensor having uniform size across a batch dimension for input to machine-learned sequence processing model 106. Decoding position 208 can advance for some of the streams and not others. For instance, decoding position 208 can be independent for each decoding stream, for each decoding group, etc. Sequence processing system 104 can read values from buffer 200 and reshape or pad the values into a tensor having uniform size across a batch dimension for input to machine-learned sequence processing model 106.

Decoding streams within a decoding group can have batchwise alignment (e.g., segments can begin at a same position in the buffer). Decoding streams across decoding groups can have different positions, as different queries may start with different initial segment lengths (e.g., after selection and broadcast of candidates with different lengths, after backtracking within a subset of decoding groups, etc.). Continuous batching techniques can be applied to manage contemporaneous decoding of multiple decoding groups having different alignment.

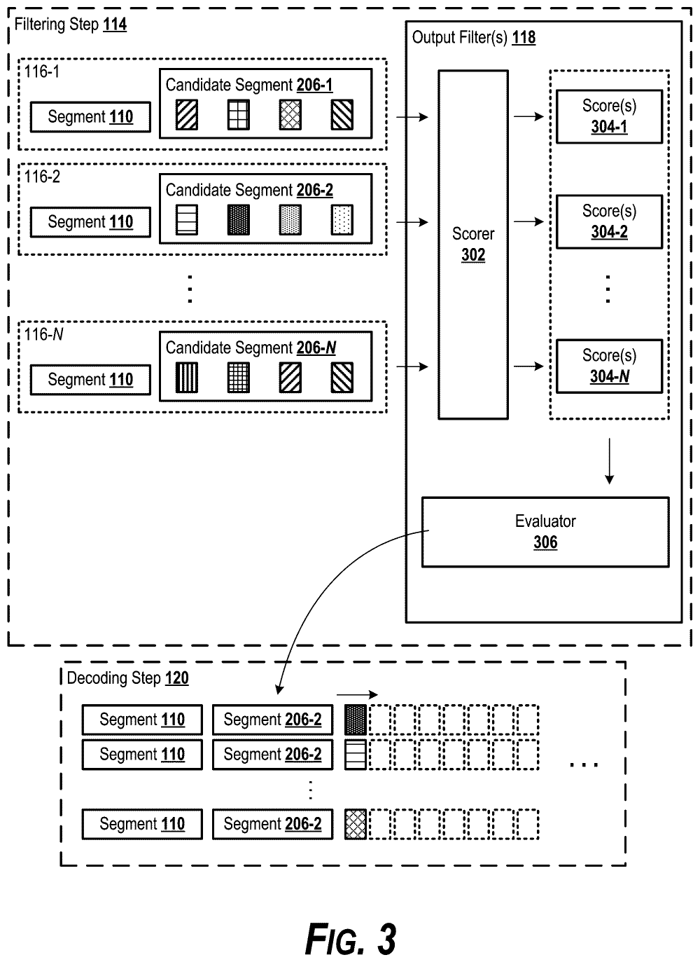

FIG. 3 is a block diagram of an example decoding and filtering cycle according to aspects of the present disclosure. In decoding step(s) 108, machine-learned sequence processing model 106 can process segment 110 to generate values for each of a plurality of candidate segments 206-1, 206-2, . . . , 206-N. Segment 110 respectively with the plurality of candidate segments 206-1, 206-2, . . . , 206-N forms a plurality of candidate sequence states 116-1, 116-2, . . . , 116-N.

Filtering step 114 can trigger after the candidate segments generated during decoding step(s) 108 satisfy a completion threshold. A scorer 302 can evaluate candidate sequence states 116-1, 116-2, . . . , 116-N to generate a plurality of scores 304-1, 304-2, . . . , 304-N that respectively correspond to candidate sequence states 116-1, 116-2, . . . , 116-N. Based on the plurality of scores, an evaluator 306 can select a highest-performing candidate (e.g., corresponding to segment 206-2 of sequence state 116-2) from among the plurality of candidates to append to the sequence.

Subsequent decoding step(s) 120 can proceed based on an output of filtering step 114. The selected candidate can be broadcast across the decoding streams (e.g., replacing or overwriting the other candidate segment values in buffer 200). Machine-learned sequence processing model 106 can attend over segment 110 and segment 206-2 to generate, for each decoding stream, new candidate segments to evaluate, filter, and append to the sequence.

Scorer 302 can include one or more machine-learned models configured to evaluate sequence inputs. The models can be configured to directly compute a numerical score corresponding to a quality of an input. For instance, a machine-learned natural language processing model can be augmented with an output head configured to output a numerical score (e.g., having a linear or nonlinear regression layer).

Scorer 302 can include sequence processing models configured generate a sequence descriptive of a quality of an input sequence. For instance, a machine-learned sequence processing scoring model can be configured to predict tokens representing numerical values that characterize a quality of an input.

Scorer 302 can include one or multiple scoring models. The scoring models can be trained to evaluate different aspects of a given input. Scorer 302 can include a mixture of experts that activate sparsely over inputs. Scorer 302 can include multiple scoring models that activate for each input (e.g., each token of each input). Scorer 302 can include a single model that provides scoring feedback along one or multiple dimensions. For instance, scorer 302 can process an input and return a sequence that evaluates the input: for example, an example response can include feedback on groundedness and helpfulness. The response can be output in an unstructured format (e.g., “groundedness is low and helpfulness is high”) or a structured format, such as JSON. In some examples, an output filter applied to scorer 302 can enforce JSON syntax (e.g., by initiating re-sampling of tokens if a sampled token does not adhere to JSON syntax). An example JSON-formatted response string follows.

```
“evaluation”: {
  “groundedness”: “low”,
  “helpfulness”: “high”,
}
```

Scorer 302 can be trained based on online or offline feedback. For instance, during a training phase, sequence processing system 104 can implement machine-learned sequence processing model 106 and output filter(s) 118 to generate multiple candidate responses. For instance, instead of returning only a best candidate response, sequence processing system 104 can return multiple candidate responses. A feedback signal can include a top-1 or a top-K selection from (or a ranking of) the multiple candidate responses. This feedback signal can be obtained from a user system or using a teacher model. A reinforcement learning algorithm can be applied to adjust parameters of scorer 302 to increase a likelihood of returning a top-ranked candidate.

Scorer 302 can be trained based on labeled training data. One or multiple scoring models of scorer 302 can be trained based on labeled scores associated with training examples (e.g., example responses, example segments, etc.).

Scorer 302 can operate with a same or different batch dimension as machine-learned sequence processing model 106. Scorer 302 can operate with a batch dimension at least having N evaluation streams.

Scores 304-1, 304-2, . . . , 304-N can be or include various different quality indicators. Scores 304-1, 304-2,., 304-N can include numerical values, categorical indicators, Boolean values, etc. Scores 304-1, 304-2, . . . , 304-N can each include multiple values for each input. Scores 304-1, 304-2, . . . , 304-N can be or include an aggregate value for each input.

Evaluator 306 can process scores 304-1, 304-2, . . . , 304-N to compare a quality of each candidate. Evaluator 306 can rank the scores to obtain a top-ranked candidate (e.g., a highest-scoring candidate, a lowest-cost candidate, etc.). Evaluator 306 can combine one or more component scores for each candidate to obtain an aggregate or composite score for comparison.

Evaluator 306 can indicate one or multiple selected candidates. For instance, evaluator 306 can implement a greedy evaluation policy under which only the top-ranked candidate is returned and used for future processing. Evaluator 306 can implement temperature sampling or other exploratory policies to include (e.g., in addition to a top-ranked candidate) an additional candidate. For example, a lower-ranked candidate can also be selected to explore whether it may eventually result in a higher-ranked output sequence.

For example, under an exploratory policy, a number of decoding streams can be allocated to exploratory decoding. For instance, after selection of a top-K set of candidates to pass on for further decoding, the top-ranked candidate can be broadcast to a first proportion of the N streams and one or more exploratory candidates can be broadcast to a second proportion of the N streams. The second proportion can be the same as or different from (e.g., smaller than) the first proportion.

In an example, an exploratory policy can carry forward a top-K set of candidates in K groups of decoding streams, with the K-th candidate being broadcast across the K-th group. The proportions of the total stream count for the K groups can be the same or can vary based on the ordinal value of the candidate among the top-K ranking (e.g., monotonically decreasing based on the ordinal value). For instance, for K=2, a top candidate can be broadcast across one half of the decoding streams and another candidate can be broadcast across the remaining half of the decoding streams. For instance, for K=4 and N=8, a top candidate can be broadcast across 4 decoding streams, the next candidate can be broadcast across 2 decoding streams, the next candidate can be broadcast across 1 decoding stream, and another candidate can be broadcast across 1 decoding stream. For instance, for K=3 and N=8, a top candidate can be broadcast across 5 decoding streams, the next candidate can be broadcast across 2 decoding streams, and another candidate can be broadcast across 1 decoding stream.

Exploratory policies can use early or late merging. For instance, early merging policies can compare all K branches against each other, selecting a new set of top-K candidates from among all N streams at subsequent filtering steps. In this manner, for instance, the best of all streams is collapsed together into a new ranking each iteration, so that each iteration can build upon the most recent best candidate. Late merging policies can compare one or more branches (e.g., each branch) within the branch. For instance, the best candidate from the K-th branch can be carried forward, maintaining the distinct style or content of K-th branch for multiple iterations. At determined intervals (e.g., every P filtering cycles), the branches can be merged by taking a new top-K evaluation across all streams. In this manner, for instance, branches can be permitted an opportunity to develop, and branch that would not have won a top-K tournament after only one cycle might, with the benefit of additional content, develop into a strong candidate.

An example exploratory policy can implement a beam search over candidate sequences.

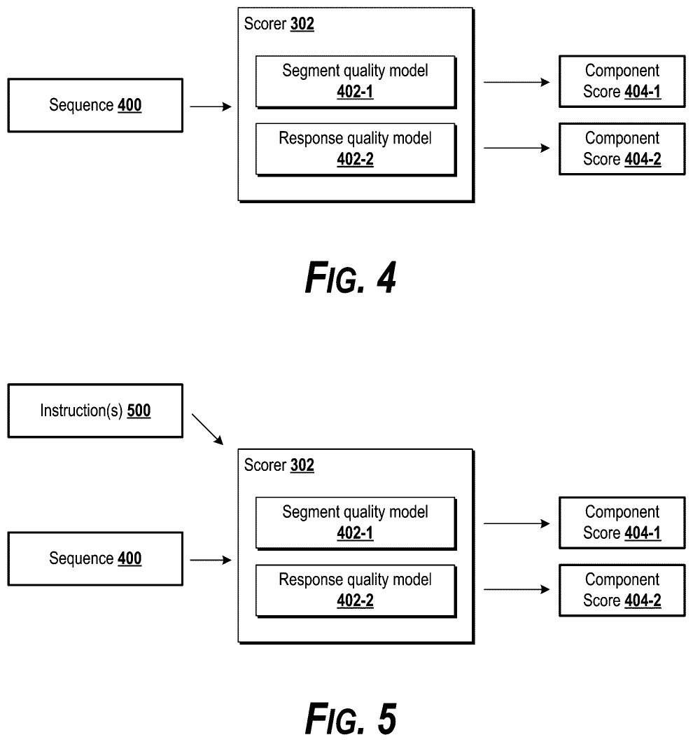

FIG. 4 is a block diagram of an example scorer 302 using multiple component models to generate multiple component scores. Scorer 302 can evaluate an input sequence 400 using a segment quality model 402-1 to generate a component score 404-1. Segment quality model 402-1 can be a machine-learned model trained to predict a quality of an input sequence for the content presented in that sequence. Scorer 302 can evaluate input sequence 400 using a response quality model 402-2 to generate a component score 404-2. Response quality model 402-2 can be a machine-learned model trained to predict an expected quality of a final response containing input sequence 400.

In this manner, for instance, scorer 302 can evaluate both a current state of sequence 400 but also predict whether the current state is likely to result in a high quality final output. This arrangement of complementary models can facilitate accurate evaluation of sequences mid-generation. For instance, consider a sequence generation request to generate a paragraph of text analyzing a particular hypothesis. A first sentence of the paragraph may set out a strong thesis but may fail to fully capture the desired analysis. As such, as a standalone segment, the first sentence might not be associated with a high quality-a single sentence might not satisfy the request for a paragraph of analysis. However, a strong thesis sentence may be associated with a high likelihood that the following paragraph adheres to the expected writing structure for a well-developed analysis. As such, as a piece of an overall response, the first sentence might be a strong signal of high quality. Advantageously, example implementations according to the present disclosure can capitalize on these dual perspectives by generating component scores for each, such that the evaluation takes into account both perspectives. Further, example implementations can account for an estimated progress in completing the full response. As the sequence states near a completed response, the sequence is increasingly complete, so a quality analysis can rely less on a predicted expected quality and more heavily weight the quality as evaluated for the current state as it stands. This weighting schedule can be hand-tuned or learned (e.g., as learnable hyperparameter(s)).

Sequence 400 can have one or more properties and characteristics as described above with respect to segment 110. An example implementation of sequence 400 can be any one of candidate sequence states 116-1, 116-2, . . . , 116-N. Also illustrated in FIG. 4 in the singular, it is to be understood that multiple sequences can be processed by scorer 302 in parallel (e.g., along a batch dimension).

Segment quality model 402-1 can be the same as (e.g., a copy of, the same model instance as) response quality model 402-2. Segment quality model 402-1 can be a different model from (e.g., a different architecture, a different set of trained weights with the same architecture, etc.) response quality model 402-2.

Segment quality model 402-1 can be or include one or more machine-learned models. Segment quality model 402-1 can be a machine-learned model configured to assess the quality of an input sequence segment by directly evaluating the content it contains. This evaluation can be based on various features such as coherence (e.g., continuity with an initial segment), grammar, relevance, adherence to a specified style or format, or any other target quality or policy. A policy can be positive (e.g., scoring desired attributes) or negative (e.g., penalizing undesired attributes).

Segment quality model 402-1 can generate scores through direct regression, where the model is augmented with a scoring output head designed to output a numerical score. For example, one or more layers of the model can take a high-dimensional representation of sequence 400 generated by preceding layers of the model and map it to a single scalar value. This scalar value can represent a quality score of the input. In an example, the model can be trained using a regression loss function, such as mean squared error, to minimize the difference between predicted quality scores and reference scores in a training dataset.

Segment quality model 402-1 can generate scores by predicting a next token in a sequence, where the tokens represent characters of numerical values corresponding to quality scores. In this case, the model can be trained as a language model that learns to predict tokens that encode quality scores.

Both direct regression and next-token prediction models can be based on various neural network architectures, such as recurrent neural networks (RNNs), long short-term memory networks (LSTMs), gated recurrent units (GRUs), or transformers. The choice of architecture can depend on factors such as the complexity of the task, the amount of training data available, and the computational resources at hand.

Response quality model 402-2 can be or include one or more machine-learned models. The architecture of response quality model 402-2 can be the same as or different from segment quality model 402-1.

The machine-learned networks used in segment quality model 402-1 or response quality model 402-2 can be the same size as or a different size from (e.g., smaller than) machine-learned sequence processing model 106. For instance, the machine-learned networks used in segment quality model 402-1 or response quality model 402-2 can be less than half the size of machine-learned sequence processing model 106. For instance, the machine-learned networks used in segment quality model 402-1 or response quality model 402-2 can be at least an order of magnitude smaller than machine-learned sequence processing model 106.

The machine-learned networks used in segment quality model 402-1 or response quality model 402-2 can execute with the same latency as or a different latency from (e.g., faster than) machine-learned sequence processing model 106. For instance, the machine-learned networks used in segment quality model 402-1 or response quality model 402-2 can execute at least twice as fast as machine-learned sequence processing model 106.

Component scores 404-1, 404-2 can be of the same or different format. Component scores 404-1 and 404-2 can include values that quantify the quality of sequence 400 from different perspectives. Score 404-1 can represent an intrinsic quality of a sequence itself, independent of its context within an expected larger sequence.

Score 404-2 can represent the predicted quality of the entire response or output sequence when it includes sequence 400 as a part. Score 404-2 can estimate the potential for the segment to contribute to a high-quality final output, such as the segment's ability to set the stage for subsequent content and its alignment with the overall narrative or argument structure. Scorer 302 can be configured to generate a score 404-2 to represent a maximum possible score out of all responses that could include sequence 400 as a part. Scorer 302 can be configured to generate a score 404-2 to represent an expected score of all responses that could include sequence 400 as a part. For instance, the loss used to train scorer 302 can cause scorer 302 to learn to regress a maximum value. The loss used to train scorer 302 can cause scorer 302 to learn to regress an expected value.

Component scores 404-1 and 404-2 can be numerical scores, such as real numbers or integers, that quantify the quality of sequence 400 based on different criteria. component scores 404-1 and 404-2 can be normalized to a common scale to enable meaningful aggregation. For example, scores can be normalized to a range between 0 and 1, where 0 represents the lowest quality and 1 represents the highest quality. Alternatively, scores can be standardized to have a mean of zero and a standard deviation of one, allowing for scores to be compared even if they originate from models with different output distributions.

Numerical scores can be based on a continuous scale, allowing for fine-grained distinctions between the quality of different segments. For example, a score of 0.85 might indicate a very high-quality segment, while a score of 0.65 might indicate a segment of moderate quality.

Numerical scores can be discretized. For instance, scores can be binned into high (e.g., 1), medium (e.g., 0.5), and low (e.g., 0) bins. For instance, for training, training examples can be binned into high, medium, and low quality bins. The training examples in each bin can be assigned a score for that bin. In this manner, the training examples can be labeled with a noisy quality signal without necessarily labeling each example individually.

Component scores 404-1 and 404-2 can be non-numerical scores, such as categorical labels or rankings. For instance, segment quality model 402-1 can output a categorical label indicating whether the segment is “coherent,” “partially coherent,” or “incoherent.” Similarly, response quality model 402-2 can output a label indicating whether an expected response is “highly responsive,” “somewhat responsive,” or “not responsive.”

Component scores can also include confidence measures or uncertainty estimates. For instance, alongside a numerical score, a scoring model can output a confidence interval or a probability distribution over possible scores, indicating the model's certainty in its evaluation. This additional information can be used by evaluator 306 to weigh scores differently based on their associated confidence levels.

Aggregation of component scores 404-1 and 404-2 into a composite score can be achieved through various methods that combine the scores into a single metric that can be used to compare and select a candidate sequence. The aggregation method can be designed to reflect the relative importance of each component score in the overall evaluation of sequence quality.

The scores can be aggregated using a weighted sum. Each component score can be multiplied by a corresponding weight, and the results can be summed to produce a composite score. The weights can be hand-tuned based on domain expertise or learned through optimization techniques (e.g., machine-learned, such as using reinforcement learning with human feedback on the outputs of sequence processing system 104). For example, if segment quality is deemed less important than response quality in the early stages of sequence generation, the weight for the response quality score may be set higher than that for the segment quality score.

A machine-learned aggregation model can take as input the component scores and output a composite score. The model can be trained on a dataset where the true quality of sequences is known, allowing it to learn the most effective way to combine the component scores. The model can be trained using reinforcement learning with human feedback on the outputs of sequence processing system 104. This approach can capture complex, non-linear relationships between the component scores. The aggregation model can also be configured to receive additional context regarding sequence 400, as the relative significance of each score can vary depending on the context (e.g., expectations for short or long responses).

A voting or ranking system can independently rank the candidates using each component score. The ranks can be combined to determine the overall ranking. For example, if one component score ranks a sequence as the best while another ranks it as the third-best, the final rank might be determined by averaging the ranks. When three or more component scores are used, a final rank can be determined by majority or plurality vote.

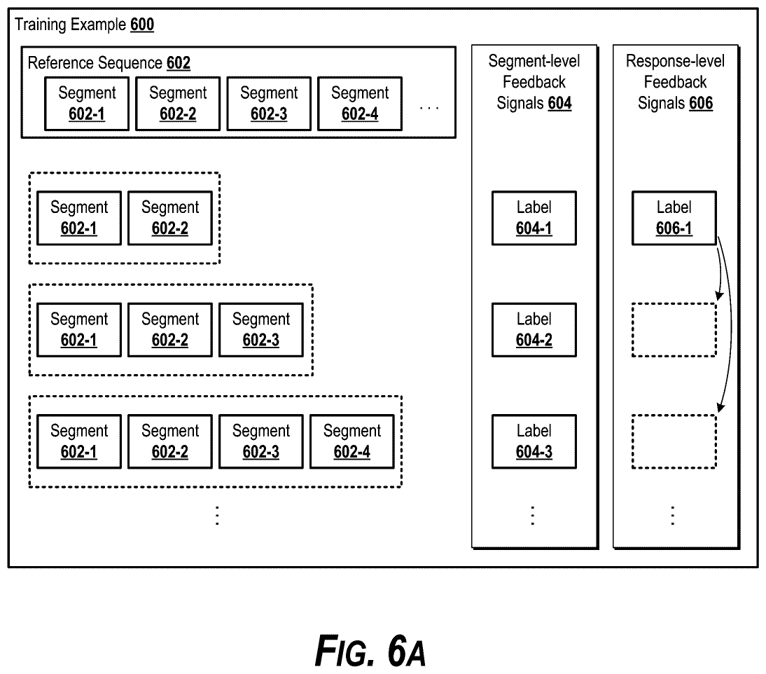

FIG. 5 is a block diagram of an example implementation of scorer 302 in which one or more of the models of scorer 302 can additionally process instructions 500. For instance, instructions 500 can include a prompt that instructs segment quality model 402-1 or response quality model 402-2 to perform the evaluation task, provides context regarding sequence 400, or otherwise augments the inputs to improve evaluation performance.

Instructions 500 can guide scorer 302 in evaluating the quality of sequence 400. These instructions can take various forms and provide different types of guidance to the scoring models, such as segment quality model 402-1 and response quality model 402-2, to ensure that the evaluation aligns with specific goals or criteria relevant to the task at hand.

Instructions 500 can include a task-specific prompt that explicitly states evaluation criteria or an evaluation policy. For example, the instruction might specify that the quality of sequence 400 should be assessed according to an explicitly provided list of features (e.g., style, tone, helpfulness, etc.). Instructions 500 can include guidelines that generally establish priorities or concerning subject matter that inform a score output without explicitly demanding an evaluation output along that axis.

Instructions 500 can include context signals that provide background information for the content of sequence 400. These context signals can help the scoring models understand the broader narrative or argument structure within which sequence 400 is situated. For instance, if sequence 400 is part of a larger document, the context signals might include a summary of the document, the content of the document, etc. This additional context can enable scorer 302 to better assess how well sequence 400 fits into the larger text and contributes to its overall coherence and flow. The context signals can also describe the original query for evaluating, for instance, helpfulness or responsiveness to the original query.

Instructions 500 can include format specifications that dictate the structure or layout expected for sequence 400. For example, if sequence 400 is intended to be a JSON-formatted data object, an instruction might specify that that score output should conform to a JSON schema.

Instructions 500 can be dynamic, with the content of the instructions evolving as the sequence generation progresses. For instance, as the sequence nears completion, the instructions might shift to signal, to the scoring model(s) a current progress or status of the generation to inform the evaluation accordingly.

Instructions 500 can be manually crafted by human operators or automatically generated by another component of sequence processing system 104 (e.g., a machine-learned sequence processing model). In some cases, instructions 500 can be derived from user input or feedback, allowing the scoring models to align their evaluations with user preferences and expectations. For instance, instructions 500 can include customized preference information for an account associated with a given sequence (e.g., an account associated with a sequence generation request 102). Instructions 500 can be parallelized along a batch dimension such that multiple different custom preferences can be input alongside multiple different sequences for parallel evaluation.

One or more scoring models can be trained on a dataset where segments and responses have been annotated with quality scores, allowing the models to learn to predict the quality of new, unseen segments. The models can be trained on a dataset without explicit quality scores, instead training the models to generate high scores for actual ground truth segments and low scores for noised or perturbed variations of the actual ground truth segments. For instance, a content generation model can be used to rewrite a ground truth segment with various errors of different severity (e.g., which can be specified a priori).

Segment quality model 402-1 and response quality model 402-2 can be trained based on online or offline feedback. For instance, during a training phase, sequence processing system 104 can implement machine-learned sequence processing model 106 and output filter(s) 118 to generate multiple candidate responses. For instance, instead of returning only a best candidate response, sequence processing system 104 can return multiple candidate responses. A feedback signal can include a top-1 or a top-K selection from (or a ranking of) the multiple candidate responses. This feedback signal can be obtained from a user system or using a teacher model. A reinforcement learning algorithm can be applied to adjust parameters of segment quality model 402-1 and response quality model 402-2 to increase a likelihood of returning a top-ranked candidate.

Training segment quality model 402-1 and response quality model 402-2 can provide a parameter-efficient mechanism for aligning a machine-learned sequence processing model 106. For instance, output characteristics of machine-learned sequence processing model 106 can be customized and adapted without updating parameters of machine-learned sequence processing model 106 itself. Segment quality model 402-1 and response quality model 402-2—which can be smaller than machine-learned sequence processing model 106—can have parameters that are unfrozen during a training phase for learning to adapt to a desired performance profile.

Advantageously, changing a desired performance profile can be efficiently implemented by swapping one or more of segment quality model 402-1 and response quality model 402-2 for a different segment quality model 402-1 or a different response quality model 402-2 that was trained to provide a different performance profile. Alternatively, different decoding groups can apply the same segment quality model 402-1 and response quality model 402-2 or different segment quality models 402-1 and response quality models 402-2.

For example, different decoding streams of a generation batch of machine-learned sequence processing model 106 can be routed to different variants of segment quality model 402-1 and response quality model 402-2. For example, a decoding group can be associated with a respective service account that has a corresponding customization profile. Decoding streams in that decoding group can be routed to a segment quality model 402-1 and response quality model 402-2 that implement filtering based on the corresponding customization profile. A different decoding group can be associated with a different customization profile. Decoding streams for that different decoding group can be routed to a segment quality model 402-1 and response quality model 402-2 that are configured differently to implement filtering based on that different customization profile.

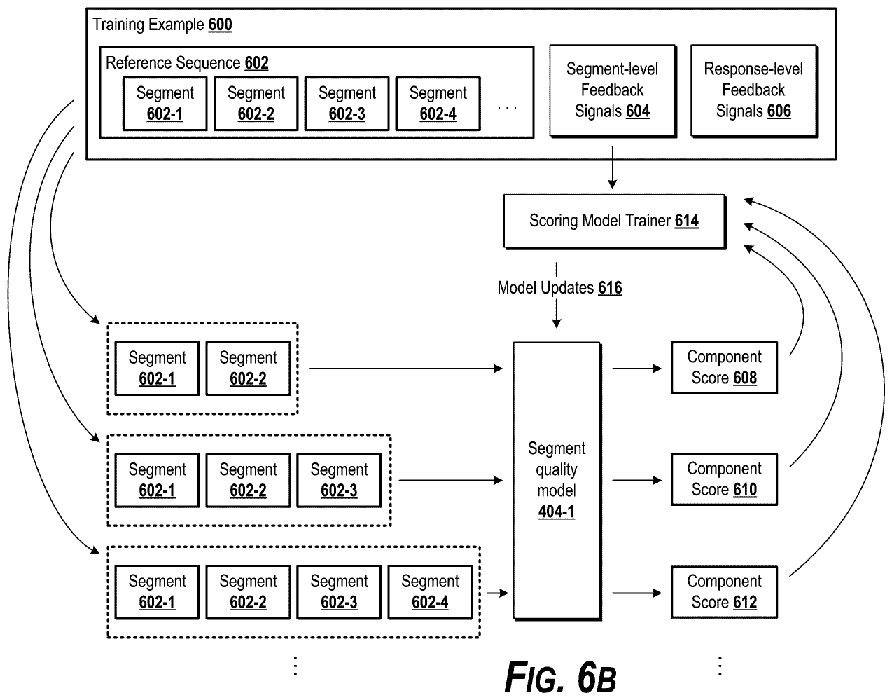

FIGS. 6A, 6B, and 6C illustrate an example technique for data-efficient training of segment quality model 402-1 and response quality model 402-2 using a shared training example. Although described herein with respect to two models 402-1 and 402-2, it is to be understood that the techniques described herein can be applied to train a single model to perform segment quality analysis and response quality prediction. For instance, a single model can have two output heads (e.g., respectively corresponding to segment quality model 402-1 and response quality model 402-2). A single encoder can respectively feed two decoders (e.g., respectively corresponding to segment quality model 402-1 and response quality model 402-2). A single model can generate an output (e.g., with a single output head) that contains a segment quality analysis output and a response quality prediction output.

FIG. 6A is a block diagram of an example training example 600. Training example 600 can include a reference sequence 602. Reference sequence 602 can include multiple segments 602-1, 602-2, 602-3, 602-4, etc. To train segment quality model 404-1 to predict segment-level quality, reference sequence 602 can be split into multiple intermediate sequence states corresponding to multiple stages of generation. For instance, an example intermediate sequence state can include segments 602-1 and 602-2. For instance, an example intermediate sequence state can include segments 602-1, 602-2, and 602-3. For instance, an example intermediate sequence state can include segments 602-1, 602-2, 602-3, and 604-4.

Training example 600 can include segment-level feedback signals 604 that include labels 604-1, 604-2, 604-3, etc. respectively for the multiple intermediate sequence states composed of segments 602-1, 602-2, 602-3, 602-4, etc. Training example 600 can include response-level feedback signals 606 that include a label 606-1 for reference sequence 602 as a whole (e.g., with respect to a query associated with training example 600, which can be included within reference sequence 602). Label 606-1 can be broadcast across all the intermediate states.

FIG. 6B is a block diagram of an example training system for training a segment quality model 402-1. To train segment quality model 404-1 to predict segment-level quality, each example intermediate sequence can provide a training pair with a corresponding segment-level feedback signal. Segment quality model 402-1 can process a given intermediate sequence state to generate a corresponding score (e.g., scores 608, 610, 612, etc.). Scoring model trainer 614 can evaluate the generated scores against the segment-level feedback signals 604 to issue model updates 616 to train segment quality model 402-1.

For a given training example 600, one or multiple intermediate sequence states can be used to train segment quality model 402-1. For instance, all possible intermediate sequence states (that have corresponding label data) can be used to train segment quality model 402-1. A subset of possible intermediate sequence states can be used to train segment quality model 402-1. For instance, one or more intermediate sequence states can be sampled from a superset of possible intermediate sequence states. In some cases, this can help decrease overfitting on individual examples. For instance, some training examples 600 may have many segments that are relatively consistent in content and theme. Decreasing a count of individual training inputs from the same training example 600 can help boost a diversity of the training for a given amount of compute.

FIG. 6C is a block diagram of an example training system for training a response quality model 402-2 using the same training example 600. To train response quality model 402-2 to predict response-level quality, each example intermediate sequence can provide a training pair with the broadcasted response-level feedback signal. Response quality model 402-2 can process a given intermediate sequence state to generate a corresponding score (e.g., scores 618, 620, 622, etc.). Scoring model trainer 614 can evaluate the generated scores against the response-level feedback signals 606 to issue model updates 624 to train response quality model 402-2.

For a given training example 600, one or multiple intermediate sequence states can be used to train response quality model 402-2. For instance, all possible intermediate sequence states (that have corresponding label data) can be used to train response quality model 402-2. A subset of possible intermediate sequence states can be used to train response quality model 402-2. For instance, one or more intermediate sequence states can be sampled from a superset of possible intermediate sequence states. In some cases, this can help decrease overfitting on individual examples. For instance, some training examples 600 may have many segments that are relatively consistent in content and theme. Decreasing a count of individual training inputs from the same training example 600 can help boost a diversity of the training for a given amount of compute.

In this manner, for instance, a single training example can be used to train both segment quality model 402-1 and response quality model 402-2, which can lead to more efficient use of training data and computational resources. Such an approach can potentially reduce the need for large, separate datasets for training each model, thereby simplifying the data collection and annotation process.

An annotation process can involve obtaining human feedback. A rating system can include an interface via which one or more intermediate sequences are presented (e.g., a query and a partial response). The rating system can provide an input interface that can receive input describing a quality of the one or more intermediate sequences. The rating system can reveal a full response. The rating system can provide an input interface that can receive input describing a quality of the full response.

Intermediate sequences can be revealed in language order (e.g., in left-to-right order for left-to-right languages) so that the human rater can review each intermediate sequence state without knowledge of the final result. The final response can be revealed last so that knowledge of the final response does not affect the evaluations of the preceding segments. In this manner, for instance, the training data can be specifically collected for training models for each distinct task: predicting intrinsic segment-level quality and predicting overall quality.

Annotation can be performed offline or online. For example, a dataset of responses can be split into semantic units (e.g., sentences) and, in an offline approach, served to one or more rating systems for collecting rating data. In an online approach, responses from a machine-learned model system (e.g., a dialog agent or other conversational interface) can be served to a user system incrementally (e.g., one semantic unit at a time), or the user system can otherwise be configured to present the response incrementally to the user with a feedback input interface being provided in association with each increment. In this manner, granular segment-level quality data can be collected in an online or offline manner.

The scoring and filtering applied in filtering step 114 can be triggered based on one or more criteria. An example trigger can include a completion threshold. For instance, a completion threshold can be configured so that a desired quantum of content has been generated in each decoding stream to facilitate a good comparison.

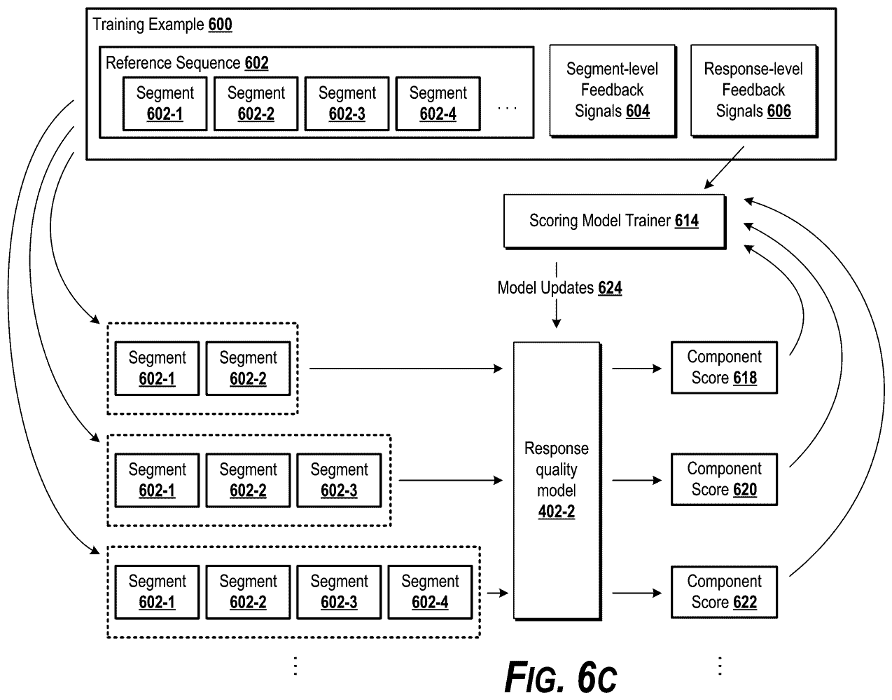

FIG. 7 is a block diagram of an example implementation of a completion threshold. During left-to-right generation 700, a completion threshold can be satisfied at point 702 at which all the decoding streams in a group have decoded a control value or token. By waiting until all candidate segments within a decoding group have reached such a control value, the system can provide that each candidate segment represents a complete thought or logical unit of content. This allows output filter(s) 118 to evaluate and compare segments that are coherent and self-contained, which can lead to more meaningful comparisons and ultimately to the generation of higher-quality content.

A control value can be or include one or more of a punctuation mark, white space, or other character or tag that indicates the end or boundary of a semantic unit. For example, in text generation, a comma (,) can indicate an end of a phrase, a semicolon (;) or colon (:) can indicate an end of a clause, a period (.) can indicate the end of a sentence, a newline character can indicate the end of a line or paragraph, and a closing bracket (]) can indicate the end of an annotated section. In the context of programming code, a semicolon (;) or newline can indicate the end of a statement, and a closing brace (}) can indicate the end of a block of code.

A control value can be a combination of characters or values. For instance, a control sequence can include a plurality of control values. For example, a control sequence can include, for instance, a punctuation mark followed by a whitespace character (e.g., “.” or “.\n”). In some examples, sampling a control value can include sampling a last control value in a control sequence (e.g., sampling a newline character token after a period token when the control sequence is “.\n”).

Control values can be predefined or learned during the training of the machine-learned sequence processing model 106.

In some implementations, some decoding streams can decode a control token before other streams. For instance, in FIG. 7, the middle decoding stream decodes a control token first, followed by the top stream and finally the bottom stream. In such cases, the decoding streams that have already generated a control token can enter a holding state while waiting for the remaining streams to reach a similar point. The holding state can involve pausing the generation of new tokens in those streams. In some cases, it may be more efficient for machine-learned sequence processing model 106 to continue decoding with consistent input/output dimensions (e.g., instead of reshaping to omit generations along a given batch row). Accordingly, some implementations can hold generations for a given stream by populating the buffer with padding tokens (e.g., equivalent to a “None” value, a zero-valued token vector, etc.) in lieu of generated tokens, or otherwise causing any subsequently generated tokens to be ignored by filters 118.

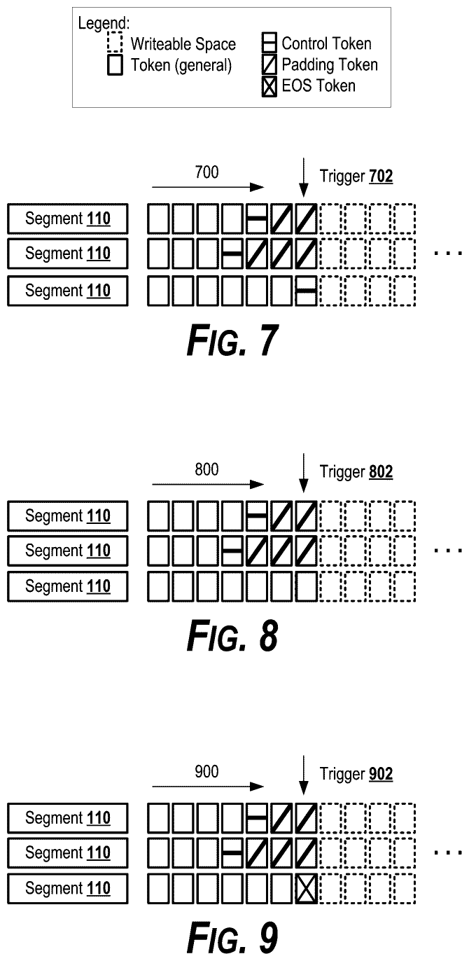

FIG. 8 is a block diagram of an example implementation of a completion threshold. During left-to-right generation 800, a completion threshold can be satisfied at point 802 at which all the decoding streams in a group have reached a designated sequence length. This can be applied in conjunction with or in a hierarchical arrangement with a proportion-based completion threshold that triggers the filtering step when a certain proportion of the decoding streams have reached a control token. For example, the threshold could be set to trigger when a given sequence length is reached and at least a majority of the streams have generated a control token.

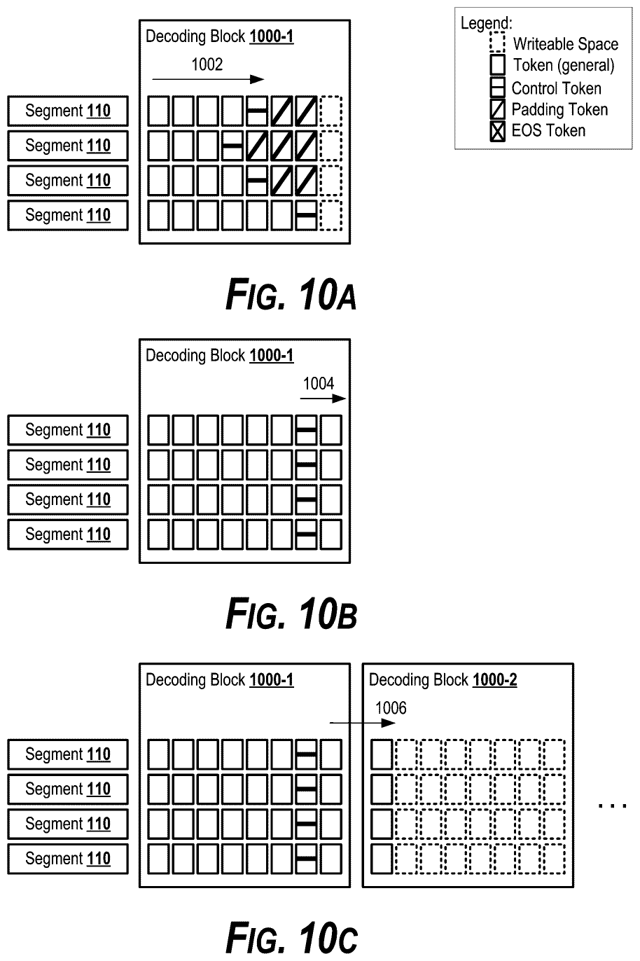

FIG. 9 is a block diagram of an example implementation of a completion threshold. During left-to-right generation 900, a completion threshold can be satisfied at point 902 at which all the decoding streams in a group have reached a control token selected from a semantic boundary control token and an end-of-sequence token.

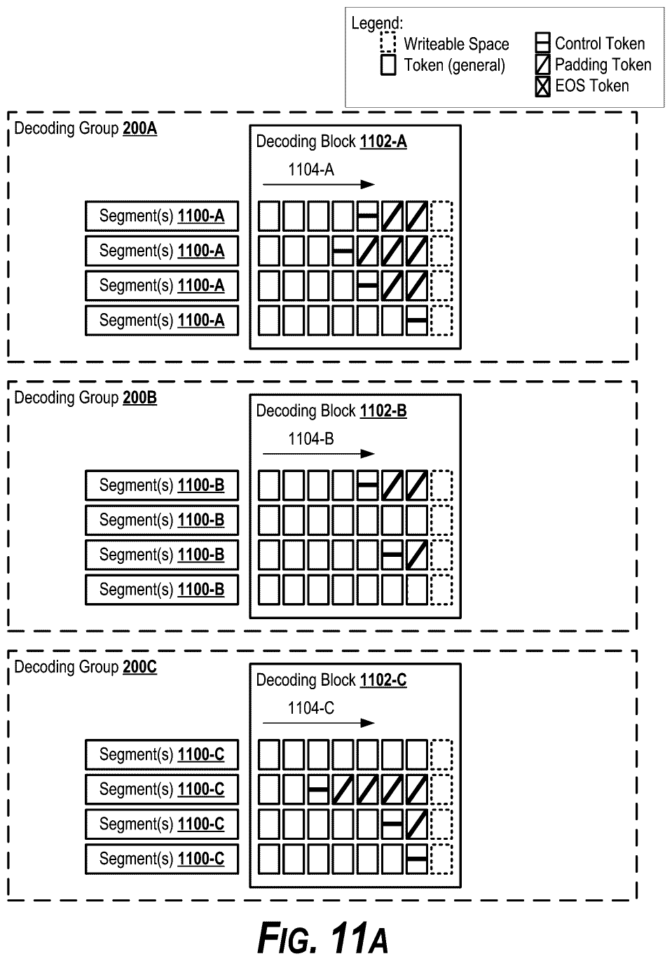

FIGS. 10A, 10B, and 10C are block diagrams of different decoding stages of an example implementation of block-based decoding. FIG. 10A illustrates a first point in time at which a decoding process 1002 has decoding a plurality of tokens that populate writeable space in decoding block 1000-1. In FIG. 10A, the decoding streams have reached a trigger condition for filtering the candidates. After filtering the candidates, a selected candidate is broadcast across the decoding streams in FIG. 10B, and decoding resumes at 1004 to populate a remaining column of writeable space in decoding block 1000-1.

FIG. 10C illustrates the initialization of a next decoding block 1000-2 upon filling decoding block 1000-1. Decoding blocks can be added on demand. Decoding blocks can be used to efficiently allocate memory for the decoding task for sequences for which a final length may be unknown a priori.

Decoding blocks 1000-1 and 1000-2 can be generated by a dynamic memory allocation system that allocates memory resources during the sequence generation process. As the sequence generation progresses and the need for additional space arises, new decoding blocks can be assigned to the buffer. The dynamic allocation of decoding blocks can be managed by a memory controller component within sequence processing system 104. The memory controller can monitor the current usage of memory within the active decoding block and initialize a new block when the available space reaches a certain threshold. The threshold can be set based on factors such as the average sequence length, the variability in sequence lengths, and the available system memory.

Each decoding block can have a predefined size. The size can be determined based on empirical data on sequence lengths or can be configurable based on the specific requirements of the sequence generation task. The size of the blocks can be chosen to balance the trade-off between the frequency of memory allocation operations and the granularity of memory usage.

The transition from one decoding block to the next, as illustrated in FIG. 10C, can be seamless from the perspective of the machine-learned sequence processing model 106. The memory controller can ensure that the model's processing logic continues uninterrupted, with the model's output being directed to the new block once the current block is filled.

A dynamic memory allocation system can manage decoding blocks 1000-1 and 1000-2 to provide a buffer 200. For instance, buffer 200 can be constructed, initialized, or loaded into active memory (e.g., a high-speed memory) on a per-block basis.

Block size can be used as a trigger for filtering step 114. For instance, a sequence length trigger can correspond to a block size. A maximum response length can correspond to a maximum number of blocks for a response. Reaching the maximum response length or number of blocks can trigger a final filtering round, even if one or more control tokens are absent from one or more decoding streams.

Processing multiple decoding groups in parallel can be configured in a variety of different ways. The groups can independently implement the decoding and filtering cycles described herein, with decoding and filtering being triggered and executed for each group independent from a state of any other group. The groups can cooperatively implement the filtering steps based on collectively satisfying a completion threshold. Examples are provided with respect to the following Figures.

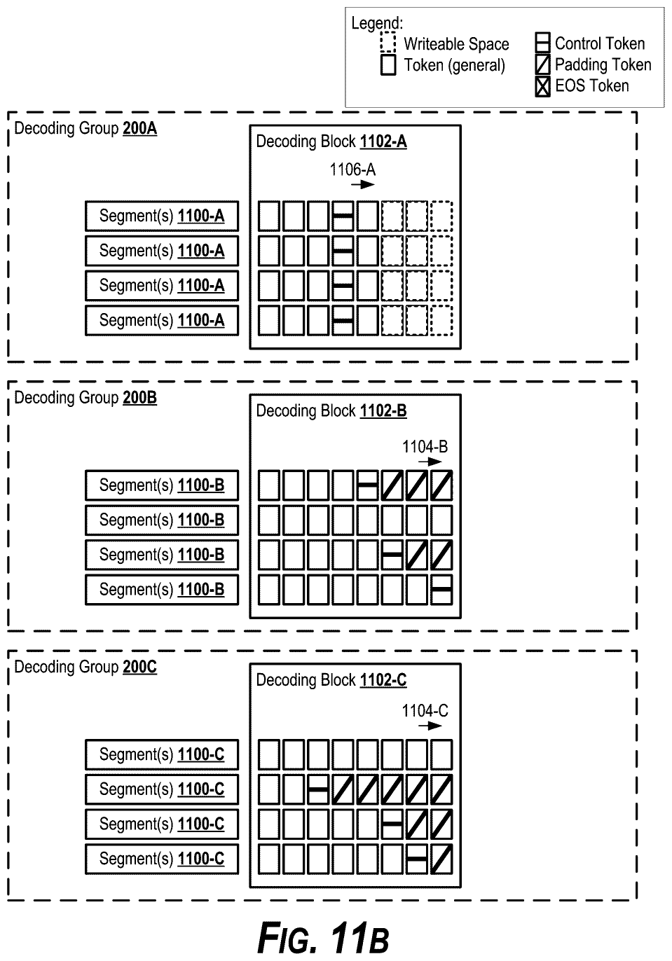

FIG. 11A is a block diagram of an example implementation for decoding three decoding groups in parallel: decoding groups 200A, 200B, and 200C. Each decoding group can generate content based on different respective initial segments 1100-A, 1100-B, and 1100-C broadcast across the respective decoding streams of the decoding groups. Decoded tokens can be written in writeable space of respective decoding blocks 1102-A, 1102-B, and 1102-C. As illustrated in FIG. 11A, each decoding group is in a first decoding cycle (e.g., corresponding to decoding step(s) 108): decoding group 200A is executing decoding step(s) 1104-A, decoding group 200B is executing decoding step(s) 1104-B, and decoding group 200C is executing decoding step(s) 1104-C.

Decoding group 200A can satisfy a completion threshold prior to one or more other groups. For instance, decoding group 200A can contain a control token in each of its decoding streams. As such, decoding group 200A can be eligible for a valid filtering step 114, even if other groups are not.

FIG. 11B is a block diagram that illustrates that output filters 118 can operate on decoding group 200A independently of the other groups. For instance, a selected candidate segment has been broadcast across group 200A, and group 200A can proceed to execute a next decoding cycle 1106-A (e.g., corresponding to decoding step(s) 120) even while decoding groups 200B and 200C are still executing cycles 1104-B, 1104-C.

In this manner, for instance, a latency of returning a response for a sequence generation request associated with decoding group 200A can be reduced, because group 200A can advance to further decoding cycles without being tied to the progress of the other groups. For instance, groups 200B or 200C could involve subject matter that tends toward long semantic units (e.g., long sentences) while group 200A could involve subject matter that tends toward short sentences. If all groups were filtered in lock step, multiple computations performed for group 200A might be replaced by padding tokens and not advance the final response.

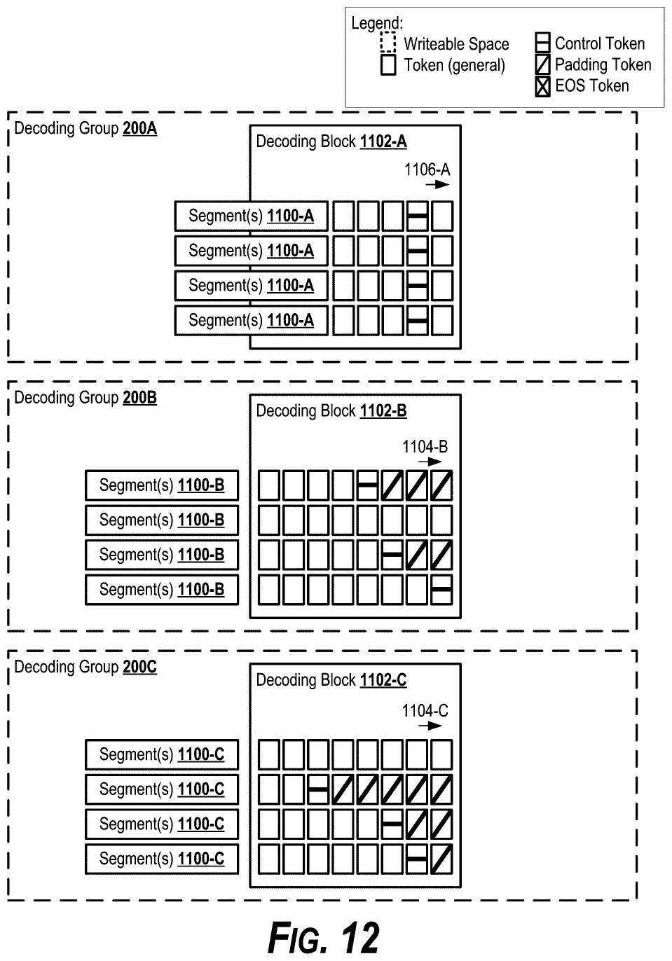

FIG. 12 is a block diagram that illustrates that the cached/buffered values for decoding group 200A can be shifted to align with decoding position of the other groups. This can be accomplished by shifting a storage position of the values in the buffer or changing a pointer value pointing to the values in the buffer.

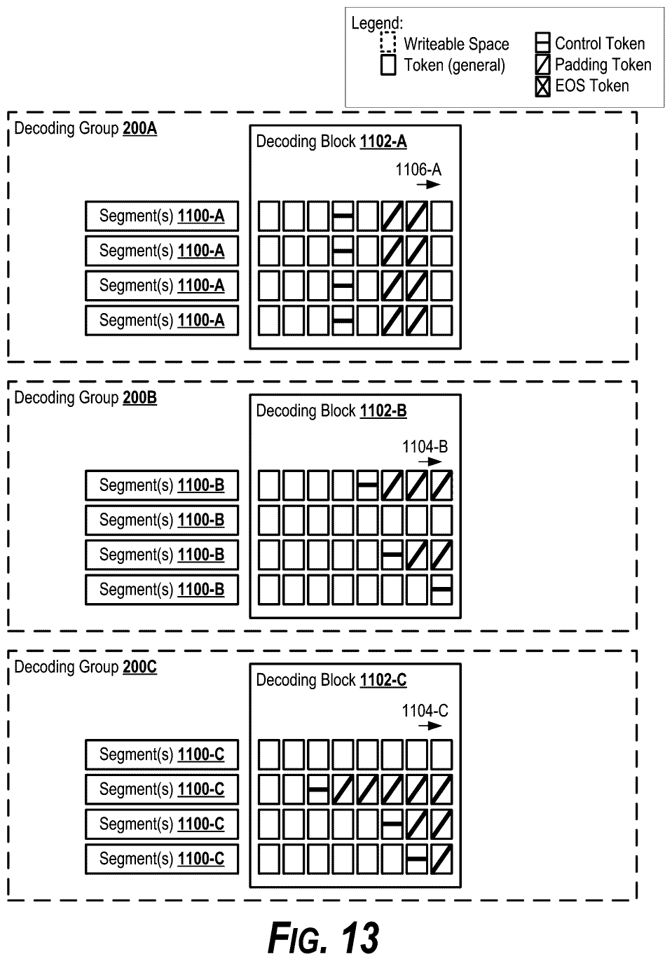

FIG. 13 is a block diagram that illustrates that the decoding position for decoding group 200A can be shifted to align with decoding position of the other groups without moving the existing stored values. For instance, padding tokens (e.g., zero-valued token embeddings) can be populated to pad the dimensions of decoding block 1102-A. The padding tokens, when processed by machine-learned sequence processing model 106, may not affect the generations and can be stripped from the final response when returned. For instance, the zero-valued vectors can effectively be overlooked by machine-learned sequence processing model 106, allowing the decoding position of group 200A to align with the other groups.

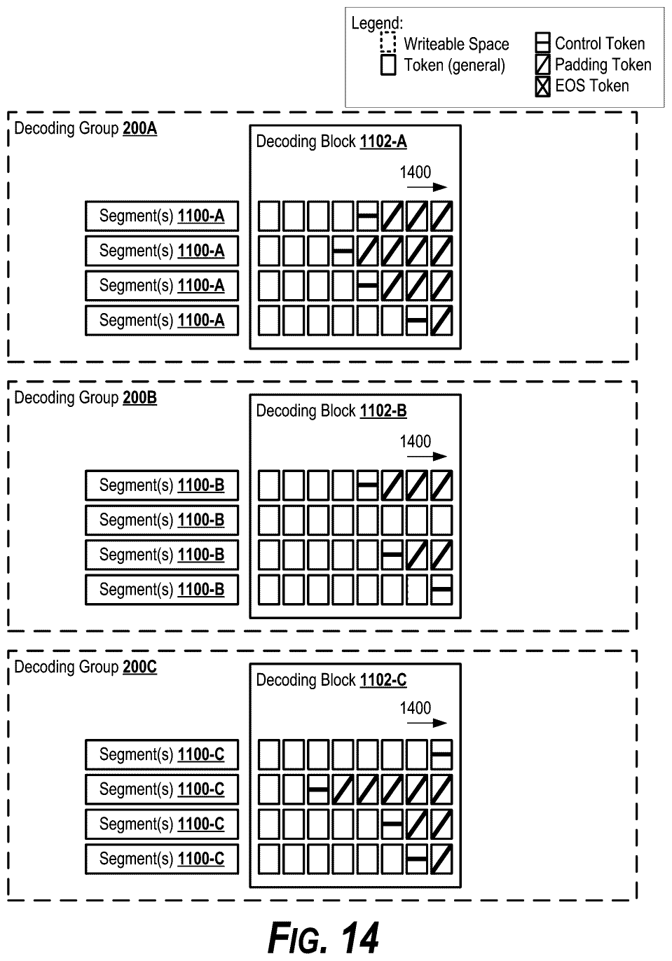

FIG. 14 is a block diagram illustrating a collective filtering trigger. For instance, decoding 1400 can proceed across all groups until all groups satisfy a collective completion threshold. A collective completion threshold can be satisfied when all (or a designated proportion of) groups satisfy their respective per-group thresholds. Example per-group thresholds are discussed above with respect to FIGS. 10A to 10C. A collective completion threshold can be satisfied when a designated proportion of the decoding streams (determined using all streams of a set of groups as a basis) satisfy a completion threshold (e.g., a threshold discussed above with respect to FIGS. 10A to 10C).

In an example, decoding 1400 can trigger a filtering step across all groups because a majority of streams contain a control token. Decoding 1400 can trigger a filtering step across all groups because an end of a decoding block has been reached. Decoding 1400 can trigger a filtering step across all groups because a designated sequence length has been reached.

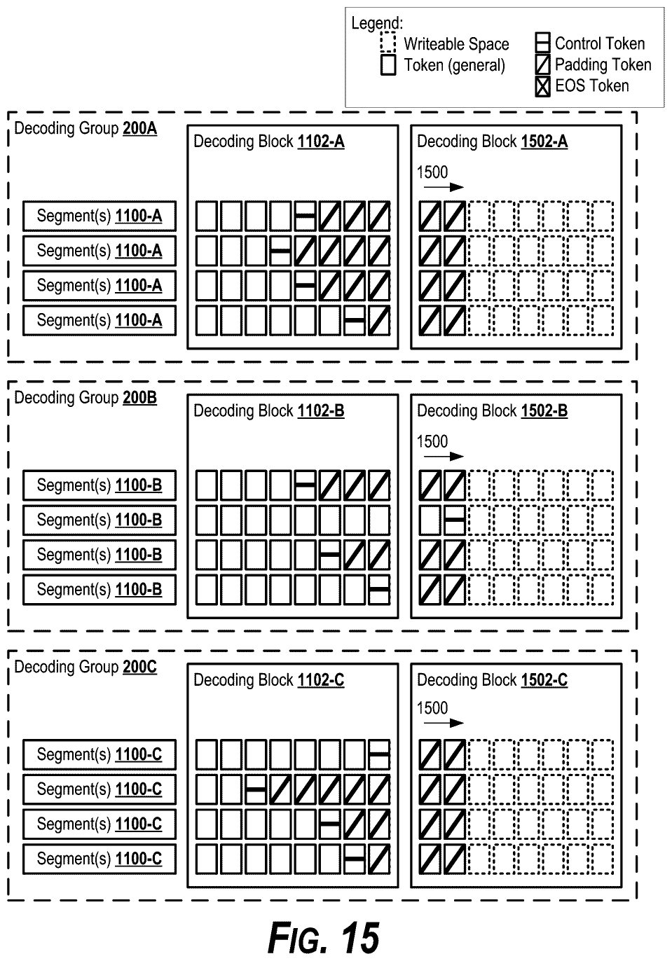

FIG. 15 is a block diagram illustrating lock-step block creation. If no trigger is determined before blocks 1102-A, 1102-B, and 1102-C are fully populated, decoding 1500 can continue and populate new decoding blocks 1502-A, 1502-B, and 1502-C. New decoding blocks can be allocated for groups 200A and 200C, even though control tokens have been decoded in each and the blocks are only being padded. This lock-step allocation can facilitate alignment of a current decoding position across the groups.

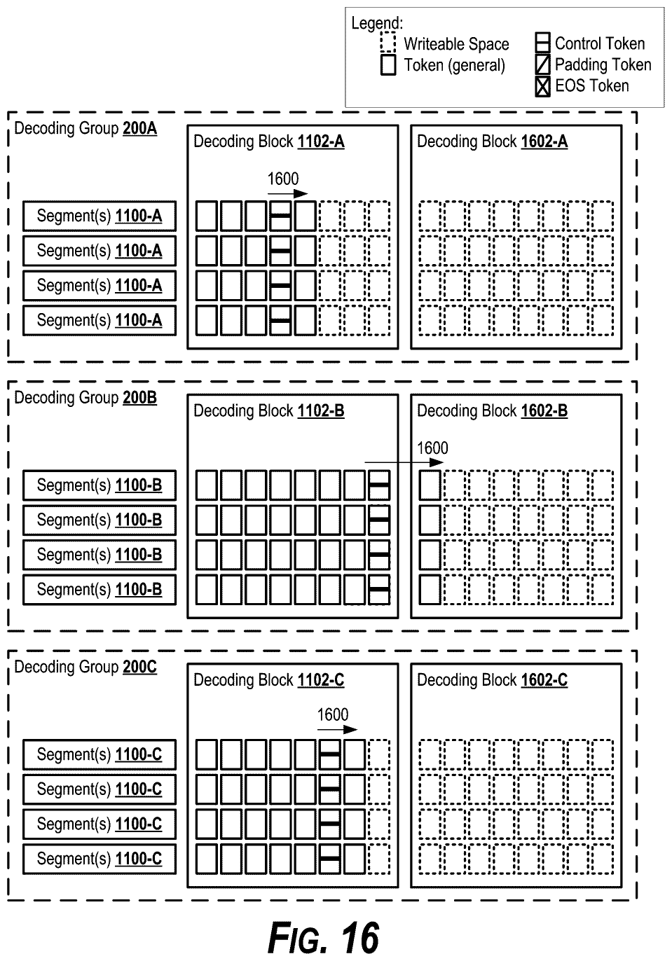

FIG. 16 is a block diagram illustrating a subsequent collective decoding cycle 1600 after collective filtering. Decoding 1600 can continue and populate new decoding blocks 1602-A, 1602-B, and 1602-C. New decoding blocks can be allocated for groups 200A and 200C, even though the preceding blocks are not yet fully populated.

The current decoding position for each group can be staggered (e.g., as illustrated in FIG. 16). It is to be understood that the current decoding position can be aligned across the groups by left padding (e.g., shifting the respective sequences in the groups, as illustrated in FIG. 12) or right padding (e.g., as illustrated in FIG. 13).

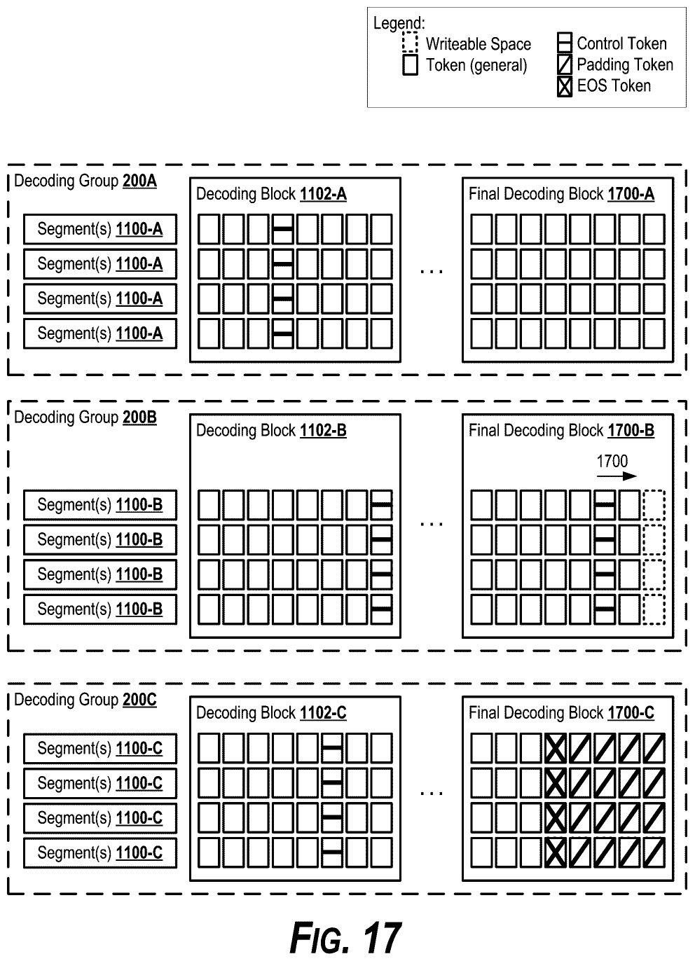

FIG. 17 is a block diagram illustrating various termination conditions for generating a response. For instance, group 200A may have fully populated a final decoding block 1700-A. Based on a length constraint (e.g., sequence length, block count), further blocks may not be assigned to group 200A such that additional generations are not being stored. As such, the group can be complete and ready for final filtering.

Group 200B, in contrast, may not have yet fully populated a final decoding block 1700-B. Decoding 1700 can continue and filtering step(s) 114 can repeat until final decoding block 1700-B is populated.

Group 200C may have decoded an EOS token in a selected candidate during a prior round of decoding and filtering. Based on the selected candidate containing an EOS token, the group can be complete and ready for output as a final response. For instance, even though there may be additional writeable space allocated for group 200C, further generation can stop because the selected candidate contained the EOS token. If a selected candidate did not contain the EOS token (even if one of the alternative candidates did contain the EOS token), further generation could continue, as in group 200B.

Completed groups can be output upon completion, even if one or more positions in a corresponding buffer portion are being padded. For instance, as soon as a group is complete, it can be passed through a final filtering round to select a candidate segment to complete the sequence. The selected candidate-if it terminates the sequence-need not be broadcast across the buffer (e.g., as illustrated in group 200C in FIG. 17) because the buffer may not be used for further generation in that group. The completed sequence can be output by sequence processing system 104 as output sequence 124.

Completed groups can be purged from a buffer so that new queries can be processed. For instance, under a continuous batching approach, as soon as a group is complete, a new group of decoding streams can be injected into the buffer in that position for decoding at the next decoding step.

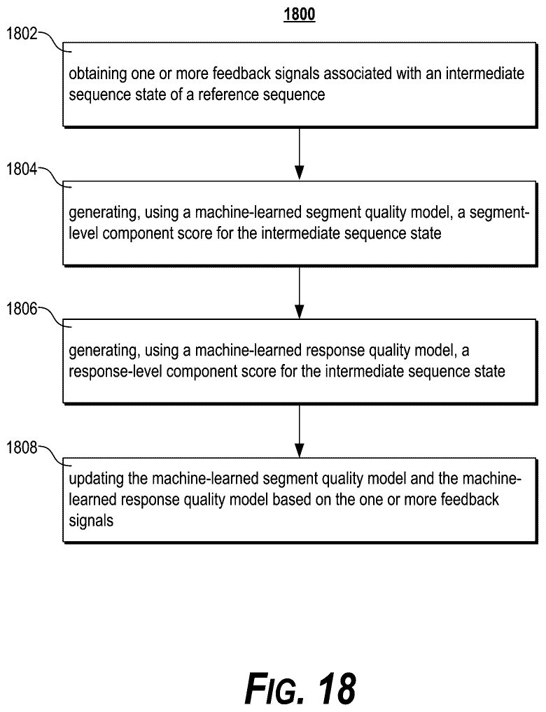

FIG. 18 depicts a flowchart of a method 1800 for training one or more machine-learned models according to aspects of the present disclosure. For instance, an example machine-learned model can include a segment quality model 402-1 or a response quality model 402-2.

One or more portion(s) of example method 1800 can be implemented by a computing system that includes one or more computing devices such as, for example, computing systems described with reference to the other figures. Each respective portion of example method 1800 can be performed by any (or any combination) of one or more computing devices. Moreover, one or more portion(s) of example method 1800 can be implemented on the hardware components of the device(s) described herein, for example, to train one or more systems or models. FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 18 is described with reference to elements/terms described with respect to other systems and figures for exemplary illustrated purposes and is not meant to be limiting. One or more portions of example method 1800 can be performed additionally, or alternatively, by other systems.

In some implementations, example method 1800 includes, at 1802, obtaining one or more feedback signals associated with an intermediate sequence state of a reference sequence. Feedback signals can be obtained from a user system via an online learning interface. Feedback signals can be obtained from a training dataset containing training examples. Feedback signals can include human or machine-generated ratings or annotations on the quality or relevance of the generated sequence. Feedback signals can be derived from human evaluations of intermediate sequence states.

In some implementations, example method 1800 includes, at 1804, generating, using a machine-learned segment quality model (e.g., model 402-1), a segment-level component score for the intermediate sequence state (e.g., a component of score(s) 304-1, 304-2, . . . , 304-N; component scores 608, 610, 612).

In some implementations, example method 1800 includes, at 1806, generating, using a machine-learned response quality model (e.g., model 402-2), a response-level component score for the intermediate sequence state (e.g., a component of score(s) 304-1, 304-2, . . . , 304-N; component scores 618, 620, 622).

In some implementations, example method 1800 includes, at 1808, updating the machine-learned segment quality model and the machine-learned response quality model based on the one or more feedback signals. For instance, a model training system can compute a gradient with respect to a loss determined using the feedback signals. The model training system can determine one or more parameter updates for the machine-learned segment quality model and the machine-learned response quality model based on the gradient (e.g., to decrease an expected value of the loss).

In some implementations of example method 1800, updating the machine-learned segment quality model and the machine-learned response quality model based on the one or more feedback signals includes updating the machine-learned segment quality model and the machine-learned response quality model to increase a reward corresponding to the one or more feedback signals. For instance, the feedback signals can correspond to an overall feedback regarding a final response. The feedback signals can correspond to a selection feedback regarding a preferred candidate from among a plurality of rendered candidates.

In some implementations, example method 1800 includes evaluating the segment-level component score using a segment-level feedback signal. In some implementations, example method 1800 includes training the machine-learned segment quality model based on the evaluation of the segment-level component score.

In some implementations, example method 1800 includes evaluating the response-level component score using a response-level feedback signal. In some implementations, example method 1800 includes training the machine-learned response quality model based on the evaluation of the response-level component score.

In some implementations of example method 1800, the intermediate sequence state is part of a segment-label pair, the segment-label pair including a training segment and a segment-level label.

In some implementations of example method 1800, the intermediate sequence state is part of a response-label pair, the response-label pair including a training segment and a response-level label, wherein the response-level label was obtained for a multi-segment response that contained the training segment.

In some implementations, example method 1800 includes determining a composite score using the first component score and the second component score. In some implementations of example method 1800, the composite score is based on a weighted combination of the segment-level component score and the response-level component score. In some implementations of example method 1800, the weighted combination is weighted based on a progress associated with the intermediate sequence state.

In some implementations of example method 1800, at least one of the segment quality model or the response quality model includes a machine-learned sequence processing model configured to process a given input segment and autoregressively generate an output segment that indicates a score. In some implementations of example method 1800, the output segment indicates numerical digits of the score. In some implementations of example method 1800, the machine-learned sequence processing model is configured to process a given input segment in conjunction with an instruction segment that instructs the machine-learned sequence processing model to provide an evaluation for one or more attributes of the given input segment.

In some implementations of example method 1800, the segment quality model includes a first machine-learned sequence processing model configured to process a given input segment and autoregressively generate an output segment that indicates a score. In some implementations of example method 1800, the response quality model includes a second machine-learned sequence processing model configured to process a given input segment and autoregressively generate an output segment that indicates a score.

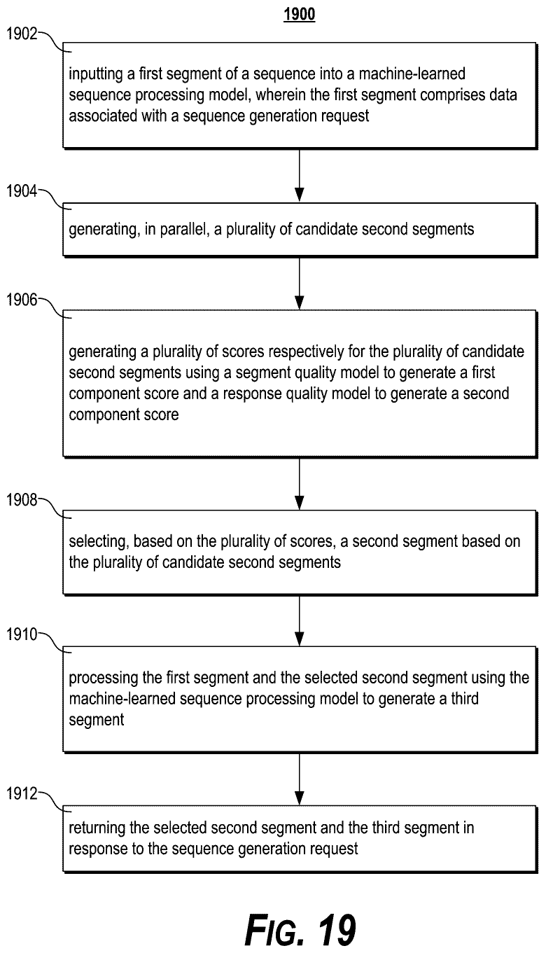

FIG. 19 depicts a flowchart of a method 1900 for implementing one or more machine-learned models according to aspects of the present disclosure. For instance, an example machine-learned model can include a segment quality model 402-1 or a response quality model 402-2.

One or more portion(s) of example method 1900 can be implemented by a computing system that includes one or more computing devices such as, for example, computing systems described with reference to the other figures. Each respective portion of example method 1900 can be performed by any (or any combination) of one or more computing devices. Moreover, one or more portion(s) of example method 1900 can be implemented on the hardware components of the device(s) described herein, for example, to implement one or more systems or models. FIG. 19 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 19 is described with reference to elements/terms described with respect to other systems and figures for exemplary illustrated purposes and is not meant to be limiting. One or more portions of example method 1900 can be performed additionally, or alternatively, by other systems.

In some implementations, example method 1900 includes, at 1902, inputting a first segment of a sequence into a machine-learned sequence processing model, wherein the first segment includes data associated with a sequence generation request. An example first segment can be, for instance, segment 110.

In some implementations, example method 1900 includes, at 1904, generating, in parallel, a plurality of candidate second segments (e.g., corresponding to N decoding streams to obtain candidate values 112-1, . . . , 112-N; candidate segments 206-1, . . . 206-N; etc.).

In some implementations, example method 1900 includes, at 1906, generating a plurality of scores respectively for the plurality of candidate second segments using a segment quality model (e.g., model 402-1) to generate a first component score and a response quality model (e.g., model 402-2) to generate a second component score.

In some implementations, example method 1900 includes, at 1908, selecting, based on the plurality of scores, a second segment (e.g., 206-2) based on the plurality of candidate second segments. For instance, a second segment can be selected from the plurality of candidate second segments. The selected second segment can be appended to the sequence to update the sequence.

In some implementations, example method 1900 includes, at 1910, processing the first segment and the selected second segment using the machine-learned sequence processing model to generate a third segment. The third segment can be appended to the sequence to update a state of the sequence (e.g., the updated sequence containing the first segment and the second segment).

In some implementations, example method 1900 includes, at 1912, returning the second segment and the third segment in response to the sequence generation request. For instance, the entire updated sequence can be returned. In some cases, the first segment may not be returned, if the first segment was originally provided to sequence processing system 104 (e.g., the recipient of the second segment and the third segment already possesses the first segment).

In some implementations of example method 1900, the segment quality model was trained using segment-level feedback signals to generate scores for input segments. In some implementations of example method 1900, the response quality model was trained using response-level feedback signals to generate a score for a given input segment based on an expected quality of a response that contains the given input segment.

In some implementations of example method 1900, the segment quality model was trained using a segment label pair, the segment label pair including a training segment and a segment-level label.

In some implementations of example method 1900, the response quality model was trained using a response label pair, the response label pair including a training segment and a response-level label, wherein the response-level label was obtained for a multi-segment response that contained the training segment.

In some implementations of example method 1900, the segment quality model was trained using reinforcement learning with the segment-level feedback signals providing a reward. In some implementations of example method 1900, the response quality model was trained using reinforcement learning with the response-level feedback signals providing a reward.

In some implementations of example method 1900, generating the plurality of scores includes, for a respective candidate second segment, determining a composite score using the first component score and the second component score.

In some implementations of example method 1900, the composite score is based on a weighted combination of the first component score and the second component score, wherein the weighted combination is weighted based on an ordinal value associated with the respective candidate second segment.

In some implementations of example method 1900, at least one of the segment quality model or the response quality model includes a machine-learned sequence processing model configured to process a given input segment and autoregressively generate an output segment that indicates a score.

In some implementations of example method 1900, the output segment indicates numerical digits of the score.

In some implementations of example method 1900, the machine-learned sequence processing model is configured to process the given input segment in conjunction with an instruction segment that instructs the machine-learned sequence processing model to provide an evaluation for one or more attributes of the given input segment.

In some implementations of example method 1900, the segment quality model includes a first machine-learned sequence processing model configured to process a given input segment and autoregressively generate an output segment that indicates a score. In some implementations of example method 1900, the response quality model includes a second machine-learned sequence processing model configured to process a given input segment and autoregressively generate an output segment that indicates a score.

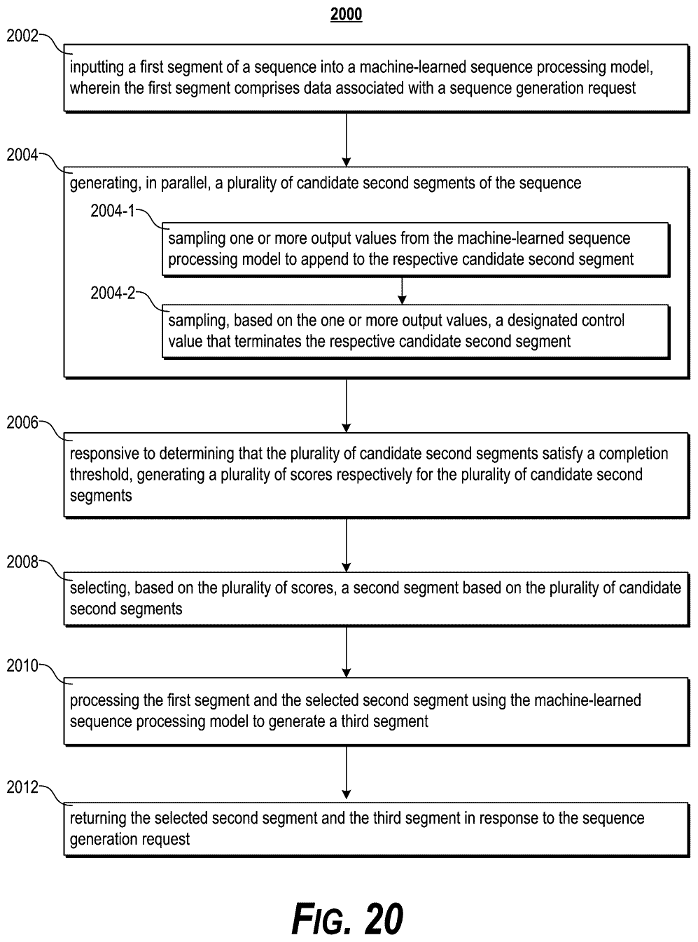

FIG. 20 depicts a flowchart of a method 2000 for implementing a sequence processing system according to aspects of the present disclosure. For instance, an example sequence processing system can include sequence processing system 104.

One or more portion(s) of example method 2000 can be implemented by a computing system that includes one or more computing devices such as, for example, computing systems described with reference to the other figures. Each respective portion of example method 2000 can be performed by any (or any combination) of one or more computing devices. Moreover, one or more portion(s) of example method 2000 can be implemented on the hardware components of the device(s) described herein, for example, to implement one or more systems or models. FIG. 20 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 20 is described with reference to elements/terms described with respect to other systems and figures for exemplary illustrated purposes and is not meant to be limiting. One or more portions of example method 2000 can be performed additionally, or alternatively, by other systems.

In some implementations, example method 2000 includes, at 2002, inputting a first segment of a sequence into a machine-learned sequence processing model, wherein the first segment includes data associated with a sequence generation request. An example first segment is segment 110.

In some implementations, example method 2000 includes, at 2004, generating, in parallel, a plurality of candidate second segments of the sequence (e.g., corresponding to N decoding streams to obtain candidate values 112-1, . . . , 112-N; candidate segments 206-1, . . . 206-N; etc.).

In some implementations of example method 2000, generating a respective candidate second segment of the plurality of candidate second segments includes, at 2004-1, sampling one or more output values from the machine-learned sequence processing model to append to the respective candidate second segment. For example, machine-learned sequence processing model 106 can decode or otherwise generate (e.g., probabilistically sample) a next sequence element for each decoding stream of a plurality of decoding streams. The probabilistic nature of sampling next tokens can provide for diversity among the candidate segments.

In some implementations of example method 2000, generating a respective candidate second segment of the plurality of candidate second segments includes, at 2004-2, sampling, based on the one or more output values, a designated control value (e.g., a control token) that terminates the respective candidate second segment. A control value can be or include a punctuation mark, white space, or other character or tag that indicates the end or boundary of a semantic unit.

In some implementations, example method 2000 includes, at 2006, responsive to determining that the plurality of candidate second segments satisfy a completion threshold, generating a plurality of scores respectively for the plurality of candidate second segments. A completion threshold can be configured so that a desired quantum of content has been generated in each decoding stream to facilitate a good scoring for comparison.

In some implementations of example method 2000, determining that the plurality of candidate second segments satisfy a completion threshold includes determining that a threshold quantity of the plurality of candidate second segments include a designated control value. For instance, during left-to-right generation, a completion threshold can be satisfied at a point at which all the decoding streams in a group have decoded a control value or token. By waiting until all (or a designated proportion of) candidate segments within a decoding group have reached such a control value, the system can provide that each candidate segment represents a complete thought or logical unit of content. This allows output filter(s) to evaluate and compare segments that are coherent and self-contained, which can lead to more meaningful comparisons and ultimately to the generation of higher-quality content.

In some implementations, example method 2000 includes, at 2008, selecting, based on the plurality of scores, a second segment (e.g., 206-2) based on the plurality of candidate second segments. For instance, a second segment can be selected from the plurality of candidate second segments. The selected second segment can be appended to the sequence to update the sequence.

In some implementations, example method 2000 includes, at 2010, processing the first segment and the selected second segment using the machine-learned sequence processing model to generate a third segment. The third segment can be appended to the sequence to update a state of the sequence (e.g., the updated sequence containing the first segment and the second segment).

In some implementations, example method 2000 includes, at 2012, returning the second segment and the third segment in response to the sequence generation request. For instance, the entire updated sequence can be returned. In some cases, the first segment may not be returned, if the first segment was originally provided to sequence processing system 104 (e.g., the recipient of the second segment and the third segment already possesses the first segment).

In some implementations of example method 2000, generating the third segment includes repeating a decoding-filtering cycle. In some implementations of example method 2000, generating the third segment includes generating, in parallel, a plurality of candidate third segments of the sequence. In some implementations of example method 2000, generating a respective candidate third segment of the plurality of candidate third segments includes sampling one or more third segment output values from the machine-learned sequence processing model to append to the respective candidate third segment. In some implementations of example method 2000, generating a respective candidate third segment of the plurality of candidate third segments includes sampling, based on the one or more third segment output values, a designated control value that terminates the respective candidate third segment.

In some implementations of example method 2000, generating the third segment includes, responsive to determining that the plurality of candidate third segments satisfy the completion threshold, generating a plurality of third segment scores respectively for the plurality of candidate third segments.

In some implementations of example method 2000, generating the third segment includes selecting, based on the plurality of third segment scores, the third segment.

In some implementations of example method 2000, the designated control value that terminates the respective candidate second segment includes a control value that represents a terminal punctuation character. For example, in text generation, a comma (,) can indicate an end of a phrase, a semicolon (;) or colon (:) can indicate an end of a clause, a period (.) can indicate the end of a sentence, a newline character can indicate the end of a line or paragraph, and a closing bracket (]) can indicate the end of an annotated section. In the context of programming code, a semicolon (;) or newline can indicate the end of a statement, and a closing brace (}) can indicate the end of a block of code.

In some implementations of example method 2000, the designated control value that terminates the respective candidate second segment includes a control value that represents a terminal punctuation character and the designated control value that terminates the respective candidate third segment includes a different terminal punctuation character from the designated control value that terminates the respective candidate second segment.

In some implementations, example method 2000 includes padding the respective candidate second segment until a predetermined segment length is reached. In some implementations, determining that the plurality of candidate second segments satisfy a completion threshold includes reaching the predetermined segment length.

In some implementations of example method 2000, processing the first segment and the selected second segment using the machine-learned sequence processing model to generate the third segment includes broadcasting the selected second segment across a batch dimension.

In some implementations of example method 2000, processing the first segment and the selected second segment using the machine-learned sequence processing model to generate the third segment includes broadcasting one or more cached attention values associated with the selected second segment across the batch dimension.

In some implementations of example method 2000, generating, in parallel, a plurality of candidate second segments of the sequence includes sharing one or more cached attention values for the first segment across the plurality of candidate second segments.

In some implementations of example method 2000, generating, in parallel, the plurality of candidate second segments of the sequence includes sharing one or more cached attention values for the first segment for the generation of the plurality of candidate second segments. In some implementations of example method 2000, generating, in parallel, the plurality of candidate third segments of the sequence includes sharing the one or more cached attention values for the first segment and one or more cached attention values for the selected second segment for the generation of the plurality of candidate third segments.

In some implementations, example method 2000 includes processing multiple batch groups, wherein each batch group is associated with a different query. In some implementations, example method 2000 includes responsive to determining that the multiple batch groups together satisfy the completion threshold, generating scores for candidate segments in each of the multiple batch groups.

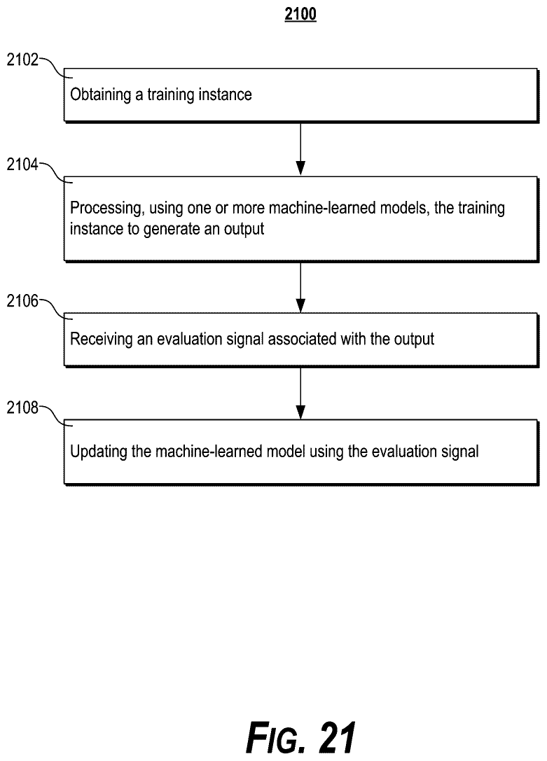

FIG. 21 depicts a flowchart of a method 2100 for training one or more machine-learned models according to aspects of the present disclosure. For instance, an example machine-learned model can include a machine-learned sequence processing model 106, machine-learned segment quality model 402-1, machine-learned response quality model 402-2, etc.

One or more portion(s) of example method 2100 can be implemented by a computing system that includes one or more computing devices such as, for example, computing systems described with reference to the other figures. Each respective portion of example method 2100 can be performed by any (or any combination) of one or more computing devices. Moreover, one or more portion(s) of example method 2100 can be implemented on the hardware components of the device(s) described herein, for example, to train one or more systems or models. FIG. 21 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 21 is described with reference to elements/terms described with respect to other systems and figures for exemplary illustrated purposes and is not meant to be limiting. One or more portions of example method 2100 can be performed additionally, or alternatively, by other systems.

At 2102, example method 2100 can include obtaining a training instance. A set of training data can include a plurality of training instances divided between multiple datasets (e.g., a training dataset, a validation dataset, or testing dataset). A training instance can be labeled or unlabeled. Although referred to in example method 2100 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 2104, example method 2100 can include processing, using one or more machine-learned models, the training instance to generate an output. The output can be directly obtained from the one or more machine-learned models or can be a downstream result of a chain of processing operations that includes an output of the one or more machine-learned models. The output can be a final output or an intermediate output (e.g., a logit value associated with a given final output candidate).

At 2106, example method 2100 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 2108, example method 2100 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 2100 can include implementing a number of generalization techniques (e.g., weight decays, dropouts, etc.) to improve the generalization capability of the models being trained.

In some implementations, example method 2100 can be implemented for training a machine-learned model from an initialized state to a fully trained state (e.g., when the model exhibits a desired performance profile, such as based on accuracy, precision, recall, etc.).

In some implementations, example method 2100 can be implemented for particular stages of a training procedure. For instance, in some implementations, example method 2100 can be implemented for pre-training a machine-learned model. Pre-training can include, for instance, large-scale training over potentially noisy data to achieve a broad base of performance levels across a variety of tasks/data types. In some implementations, example method 2100 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

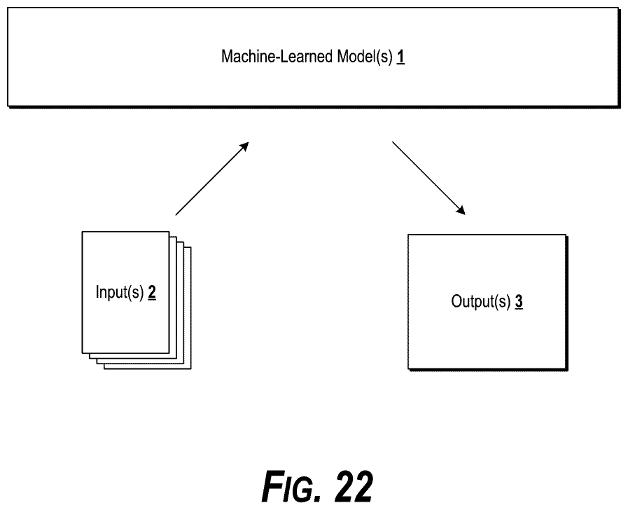

FIG. 22 is a block diagram of an example processing flow for using machine-learned model(s) 1 to process input(s) 2 to generate output(s) 3.

Machine-learned model(s) 1 can be or include any one of or any part of machine-learned models referenced with respect to the preceding figures (e.g., models 106, 402-1, 402-2, etc.). For example, any one or multiple of machine-learned models 106, 402-1, 402-2, etc. can be a machine-learned model 1. Features and variations described herein with respect to machine-learned model 1 are to be understood as describing features and variations of any of the machine-learned models described herein. Where this description references machine-learned model 1 it is to be understood that implementations of each of the other models described herein are implicitly referenced and represented thereby.

Machine-learned model(s) I can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) I can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

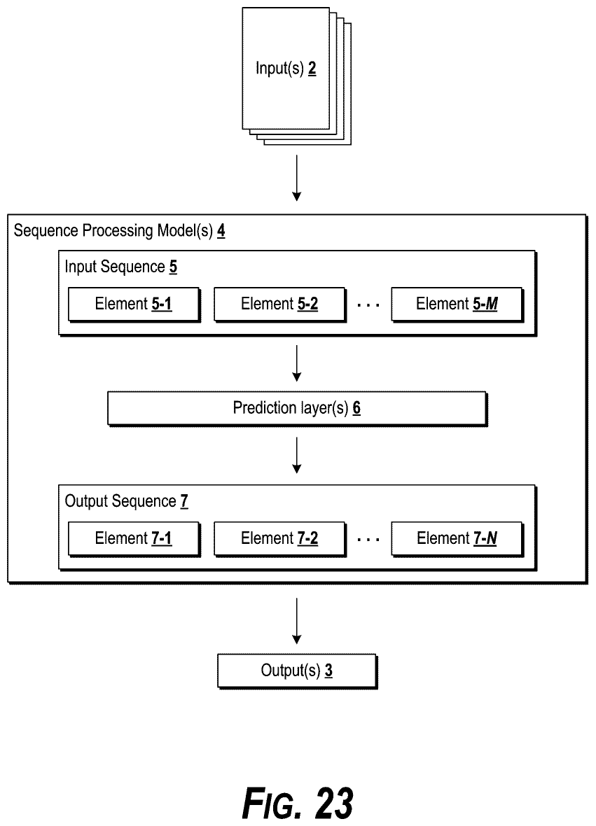

FIG. 23 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. Sec, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 23 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multilayer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

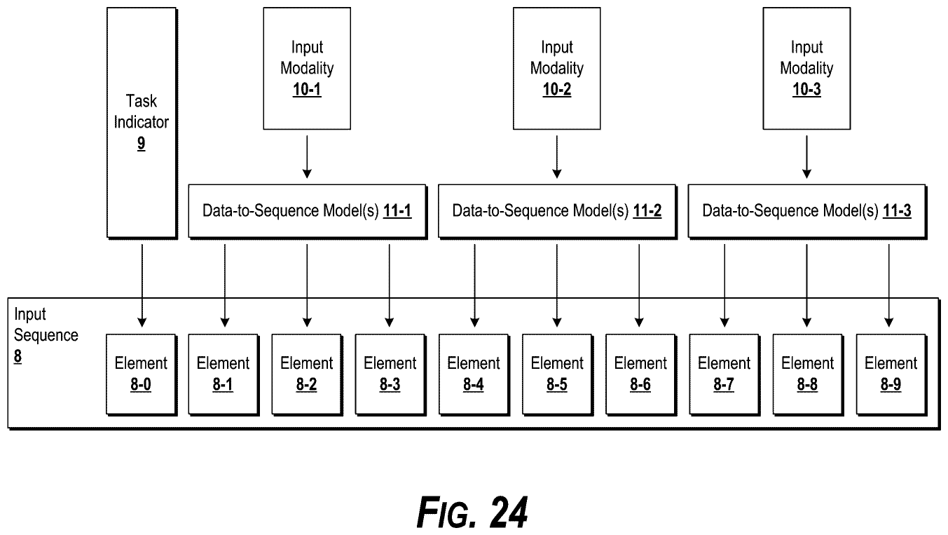

FIG. 24 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

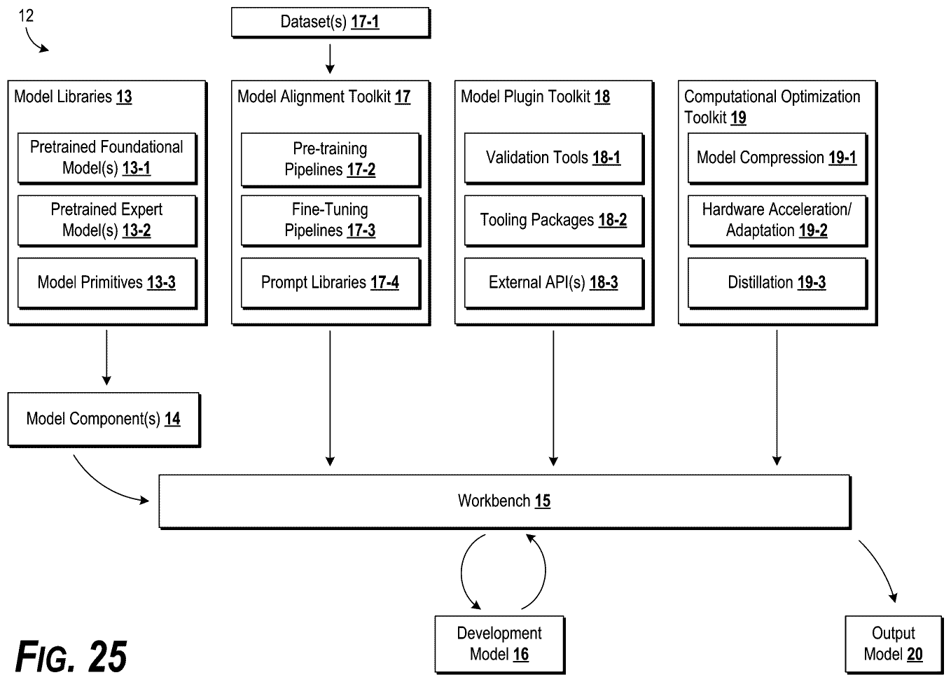

FIG. 25 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

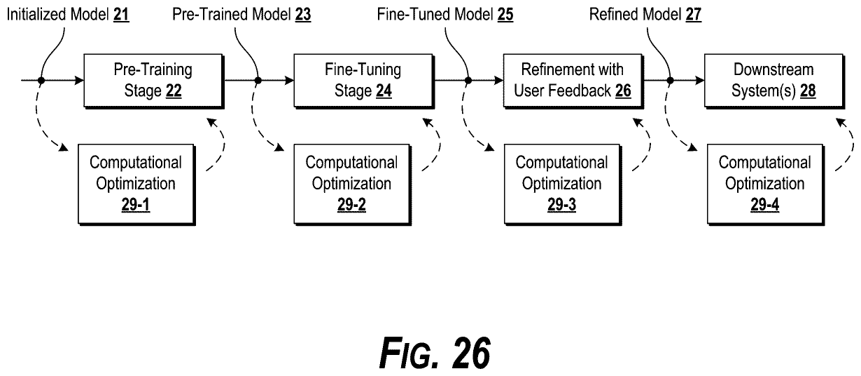

FIG. 26 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

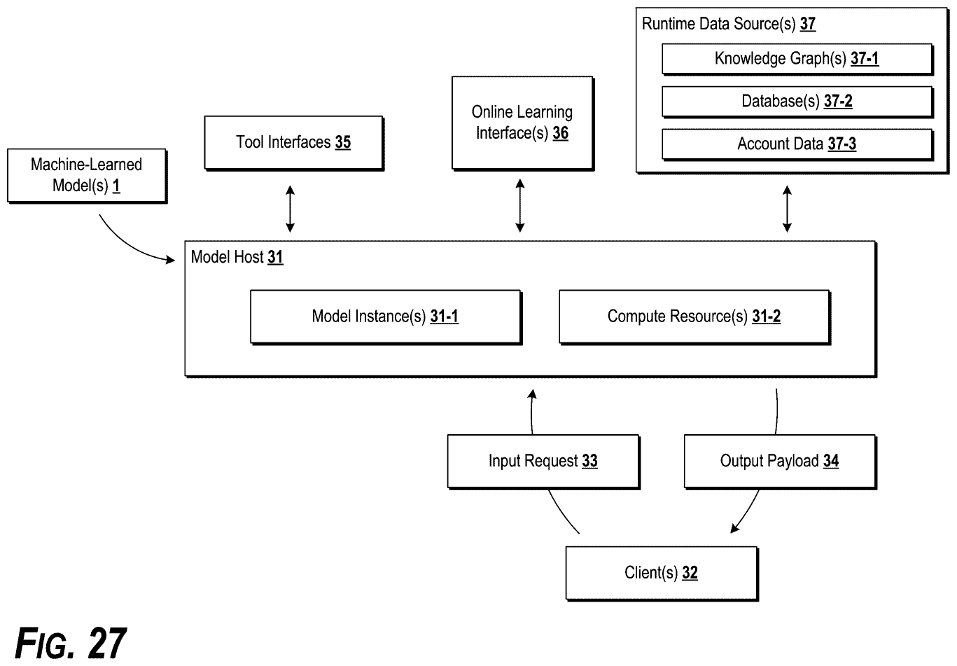

FIG. 27 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) I can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) I can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) I can process the speech data to generate a speech translation output. As another example, machine-learned model(s) 1 can process the speech data to generate a latent embedding output. As another example, machine-learned model(s) I can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) I can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) I can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) I can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) I can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

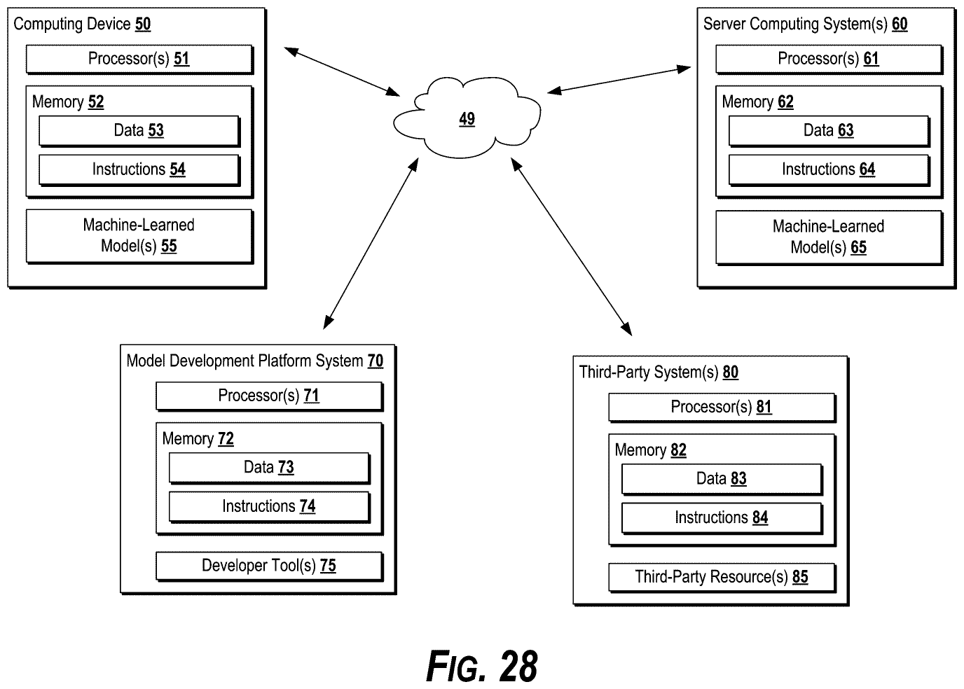

FIG. 28 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 28 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 28 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

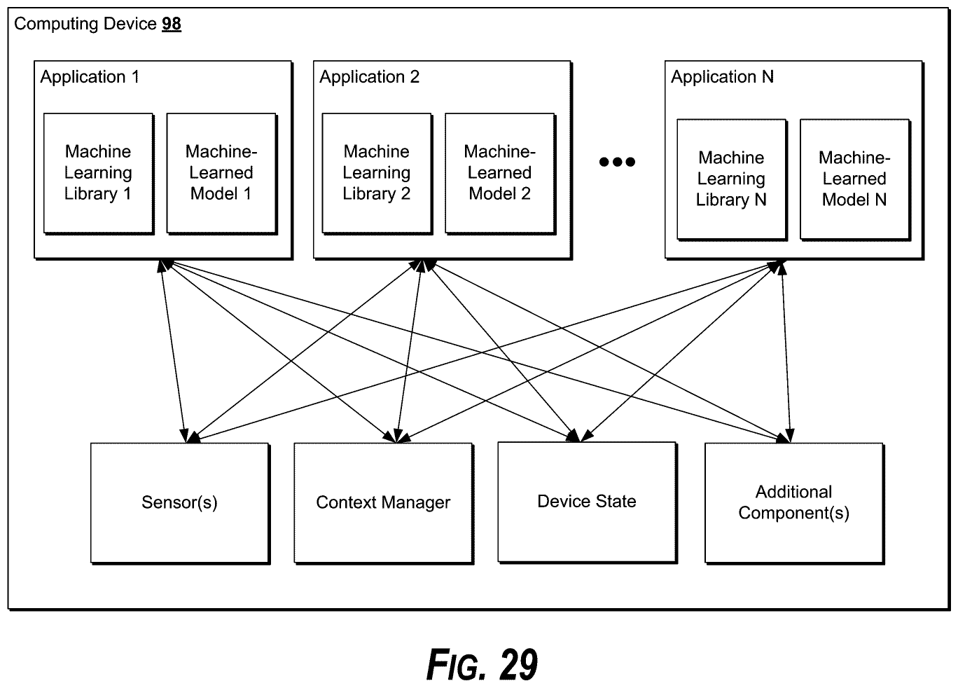

FIG. 29 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 29, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

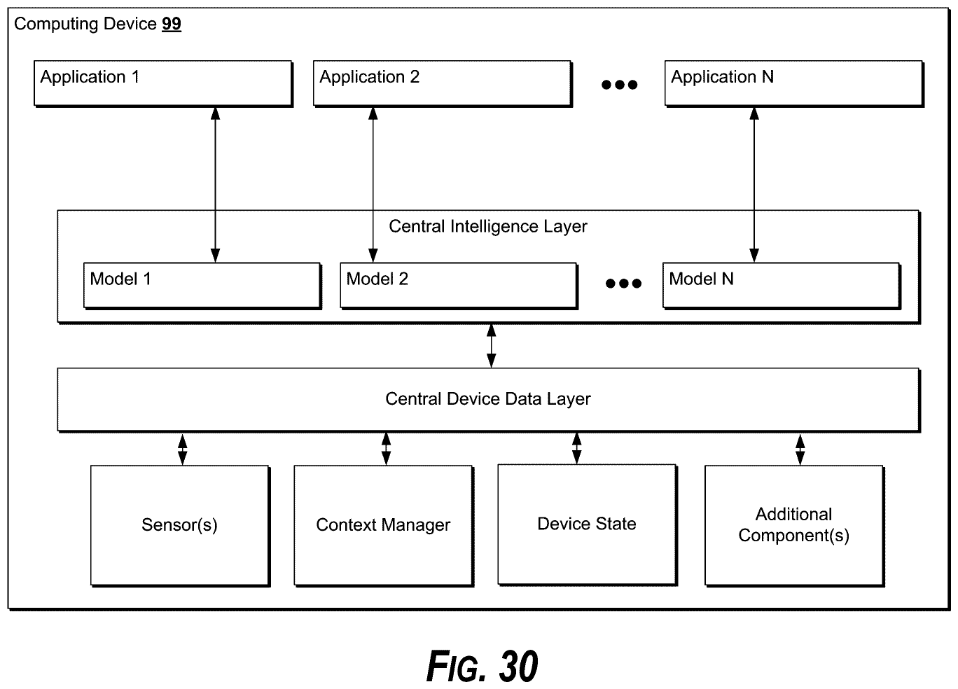

FIG. 30 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 30, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 30, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system configured for generation of multiple candidate segments of a multi-segment sequence using a machine-learned sequence processing model, the computing system comprising:
one or more processors; and
one or more non-transitory computer-readable media storing instructions that are executable by the one or more processors to cause the computing system to perform operations, the operations comprising:
inputting a first segment of a sequence into a machine-learned sequence processing model, wherein the first segment comprises data associated with a sequence generation request;
generating, in parallel, a plurality of candidate second segments;
generating a plurality of scores respectively for the plurality of candidate second segments using a segment quality model to generate a first component score and a response quality model to generate a second component score;
selecting, based on the plurality of scores, a second segment based on the plurality of candidate second segments;
processing the first segment and the selected second segment using the machine-learned sequence processing model to generate a third segment; and
returning the selected second segment and the third segment in response to the sequence generation request.

2. The computing system of claim 1, wherein:
the segment quality model was trained using segment-level feedback signals to generate scores for input segments; and
the response quality model was trained using response-level feedback signals to generate a score for a given input segment based on an expected quality of a response that contains the given input segment.

3. The computing system of claim 2, wherein the segment quality model was trained using a segment label pair, the segment label pair comprising a training segment and a segment-level label.

4. The computing system of claim 2, wherein the response quality model was trained using a response label pair, the response label pair comprising a training segment and a response-level label, wherein the response-level label was obtained for a multi-segment response that contained the training segment.

5. The computing system of claim 2, wherein:
the segment quality model was trained using reinforcement learning with the segment-level feedback signals providing a reward; or
the response quality model was trained using reinforcement learning with the response-level feedback signals providing a reward.

6. The computing system of claim 1, wherein generating the plurality of scores comprises, for a respective candidate second segment:
determining a composite score using the first component score and the second component score.

7. The computing system of claim 6, wherein the composite score is based on a weighted combination of the first component score and the second component score, wherein the weighted combination is weighted based on an ordinal value associated with the respective candidate second segment.

8. The computing system of claim 1, wherein at least one of the segment quality model or the response quality model comprises a machine-learned sequence processing model configured to process a given input segment and autoregressively generate an output segment that indicates a score.

9. The computing system of claim 8, wherein the output segment indicates numerical digits of the score.

10. The computing system of claim 8, wherein the machine-learned sequence processing model is configured to process the given input segment in conjunction with an instruction segment that instructs the machine-learned sequence processing model to provide an evaluation for one or more attributes of the given input segment.

11. The computing system of claim 2, wherein:
the segment quality model comprises a first machine-learned sequence processing model configured to process a given input segment and autoregressively generate an output segment that indicates a score; and
the response quality model comprises a second machine-learned sequence processing model configured to process a given input segment and autoregressively generate an output segment that indicates a score.

12. A computing system configured for generation of multiple candidate segments of a multi-segment sequence using a machine-learned sequence processing model, the computing system comprising:
one or more processors; and
one or more non-transitory computer-readable media storing instructions that are executable by the one or more processors to cause the computing system to perform operations, the operations comprising:
inputting a first segment of a sequence into a machine-learned sequence processing model, wherein the first segment comprises data associated with a sequence generation request;
generating, in parallel, a plurality of candidate second segments of the sequence, wherein generating a respective candidate second segment of the plurality of candidate second segments comprises:
sampling one or more output values from the machine-learned sequence processing model to append to the respective candidate second segment; and
sampling, based on the one or more output values, a designated control value that terminates the respective candidate second segment;
responsive to determining that the plurality of candidate second segments satisfy a completion threshold, generating a plurality of scores respectively for the plurality of candidate second segments;
selecting, based on the plurality of scores, a second segment based on the plurality of candidate second segments;
processing the first segment and the selected second segment using the machine-learned sequence processing model to generate a third segment; and
returning the selected second segment and the third segment in response to the sequence generation request.

13. The computing system of claim 12, wherein generating the third segment comprises:
generating, in parallel, a plurality of candidate third segments of the sequence, wherein generating a respective candidate third segment of the plurality of candidate third segments comprises:
sampling one or more third segment output values from the machine-learned sequence processing model to append to the respective candidate third segment; and
sampling, based on the one or more third segment output values, a designated control value that terminates the respective candidate third segment;
responsive to determining that the plurality of candidate third segments satisfy the completion threshold, generating a plurality of third segment scores respectively for the plurality of candidate third segments;
selecting, based on the plurality of third segment scores, the third segment.

14. The computing system of claim 12, wherein the designated control value that terminates the respective candidate second segment comprises a control value that represents a terminal punctuation character.

15. The computing system of claim 13, wherein:
the designated control value that terminates the respective candidate second segment comprises a control value that represents a terminal punctuation character; and
the designated control value that terminates the respective candidate third segment comprises a different terminal punctuation character from the designated control value that terminates the respective candidate second segment.

16. The computing system of claim 12, wherein determining that the plurality of candidate second segments satisfy a completion threshold comprises:
determining that a threshold quantity of the plurality of candidate second segments comprise a designated control value.

17. The computing system of claim 12, wherein the operations comprise:
padding the respective candidate second segment until a predetermined segment length is reached;
wherein determining that the plurality of candidate second segments satisfy a completion threshold comprises reaching the predetermined segment length.

18. The computing system of claim 12, wherein processing the first segment and the selected second segment using the machine-learned sequence processing model to generate the third segment comprises:
broadcasting the selected second segment across a batch dimension.

19. The computing system of claim 18, wherein processing the first segment and the selected second segment using the machine-learned sequence processing model to generate the third segment comprises:
broadcasting one or more cached attention values associated with the selected second segment across the batch dimension.

20. The computing system of claim 12, wherein generating, in parallel, the plurality of candidate second segments of the sequence comprises:
sharing one or more cached attention values for the first segment across the plurality of candidate second segments.

21. The computing system of claim 13, wherein:
generating, in parallel, the plurality of candidate second segments of the sequence comprises:
sharing one or more cached attention values for the first segment for the generation of the plurality of candidate second segments; and
generating, in parallel, the plurality of candidate third segments of the sequence comprises:
sharing the one or more cached attention values for the first segment and one or more cached attention values for the selected second segment for the generation of the plurality of candidate third segments.

22. The computing system of claim 12, wherein the operations comprise:
processing multiple batch groups, wherein each batch group is associated with a different query; and
responsive to determining that the multiple batch groups together satisfy the completion threshold, generating scores for candidate segments in each of the multiple batch groups.

23. A computing system configured for training a plurality of scoring models for efficient generation of multiple candidate segments of a multi-segment sequence using a machine-learned sequence processing model, the computing system comprising:
one or more processors; and
one or more non-transitory computer-readable media storing instructions that are executable by the one or more processors to cause the computing system to perform operations, the operations comprising:
obtaining one or more feedback signals associated with an intermediate sequence state of a reference sequence;
generating, using a machine-learned segment quality model, a segment-level component score for the intermediate sequence state;
generating, using a machine-learned response quality model, a response-level component score for the intermediate sequence state; and
updating the machine-learned segment quality model and the machine-learned response quality model based on the one or more feedback signals.
